(19) United States
(12) Patent Application Publication
(10) Pub. No.: US 2025/0253697 A1
(43) Pub. Date: Aug. 7, 2025

(54) STORAGE BATTERY CONTROL DEVICE AND ELECTRICITY STORAGE SYSTEM

(71) Applicant: YAZAKI CORPORATION, Tokyo (JP)

(72) Inventor: Takahiro Syouda, Susono-shi (JP)

(21) Appl. No.: 19/190,592

(22) Filed: Apr. 26, 2025

Related U.S. Application Data
(63) Continuation of application No. PCT/JP2023/038796, filed on Oct. 26, 2023.

(30) Foreign Application Priority Data
Nov. 29, 2022 (JP) 2022-189832

(51) Int. Cl. H02J 7/00; H01M 10/42; H01M 10/48; H01M 50/509

(52) U.S. Cl. CPC H02J 7/00712; H01M 10/425; H01M 10/482; H01M 50/509; H02J 7/00032; H02J 7/0013; H02J 7/0069; H01M 2010/4271; H01M 2010/4278

(57) ABSTRACT

A storage battery control device includes a plurality of first control devices that are provided respectively for strings and configured to control a string auxiliary device, and a second control device configured to communicate with the plurality of first control devices and a host server outside an electricity storage system. The first control device is configured to acquire information on states of the strings and transmit the information to the second control device. The second control device is configured to calculate an instruction value of charge and discharge power assigned to each of strings based on an instruction value of charge and discharge power of the electricity storage system received from the host server and information on the states of the strings received from the plurality of first control devices, and transmit the instruction value of charge and discharge power to the first control devices.

### CROSS-REFERENCE TO RELATED APPLICATIONS

This is a continuation of International Application No. PCT/JP2023/038796 filed on Oct. 26, 2023, and claims priority from Japanese Patent Application No. 2022-189832 filed on Nov. 29, 2022, the entire content of which is incorporated herein by reference.

### TECHNICAL FIELD

The present invention relates to a storage battery control device and an electricity storage system.

### BACKGROUND ART

There is known an electricity storage system that includes a plurality of storage battery strings connected in parallel (see, for example, Patent Literature 1). In the electricity storage system disclosed in Patent Literature 1, the storage battery string includes a plurality of storage batteries connected in series and a power converter. The power converter is controlled by a controller to convert an output of the storage battery string into a set voltage of a load supply bus.

As the electricity storage system including a plurality of storage battery strings connected in parallel, there is known an electricity storage system including a plurality of bypass switch units provided respectively for a plurality of storage batteries connected in series, and a plurality of string interruption switches provided respectively for the storage battery strings (see, for example, Patent Literature 2). In the electricity storage system disclosed in Patent Literature 2, the bypass switch unit is controlled by a controller to switch the storage battery between a connected state and a bypass state. In addition, the string interruption switch is controlled by a controller to switch the storage battery string between a connected state and an interrupted state.

Further, there is known an electricity storage system that executes a temperature adjustment control of a battery in response to a request of a demand response (hereinafter, referred to as DR) (see, for example, Patent Literature 3). In the electricity storage system disclosed in Patent Literature 3, in a case where a charge and discharge control is executed so as to alleviate power shortage of the power grid, the execution of the temperature adjustment control is restricted.

### CITATION LIST

### Patent Literature

Patent Literature 1: JP2020-156200A
Patent Literature 2: JP2022-29299A
Patent Literature 3: JP2021-191157A

### SUMMARY OF INVENTION

### Technical Problem

There is assumed a large-scale electricity storage system in which a large number of storage battery strings are provided, and each storage battery string is provided with a power converter, a large number of storage batteries, and a large number of bypass switch units. In this assumption, in order to execute a charge and discharge control in response to a request of a DR, it is necessary to manage an amount of stored power in units of the storage battery strings or in units of the storage batteries. However, in the large-scale electricity storage system, since the number of the storage battery strings increases and the number of the storage batteries further increases, it is necessary to avoid complexity of the control by a control device and to appropriately prevent a processing load of the control device.

The present invention has been made in view of the above circumstances, and an object of the present invention is to provide a storage battery control device and an electricity storage system capable of managing an amount of stored power in a unit of a storage battery string and a unit of a storage battery and appropriately preventing a processing load of a control device even in a large-scale electricity storage system.

### Solution to Problem

The storage battery control device of the present invention is a storage battery control device for controlling an electricity storage system including a plurality of storage battery strings connected in parallel, the storage battery string including a plurality of storage batteries connected in series, a plurality of bypass circuits that are provided respectively for the storage batteries and configured to switch the storage batteries between a bypass state and a connected state, and a power converter configured to convert input and output power of the storage battery string, the storage battery control device including: a plurality of first control units that are provided respectively for the storage battery strings and configured to control auxiliary devices of the storage battery strings including the power converter and the bypass circuits; and a second control unit configured to communicate with the plurality of first control units and a system outside the electricity storage system. In the storage battery control device, the first control unit is configured to acquire information on states of the storage battery strings and transmit the information to the second control unit, the second control unit is configured to calculate an instruction value of charge and discharge power or a charge and discharge current assigned to each of the plurality of storage battery strings based on an instruction value of charge and discharge power or a charge and discharge current of the electricity storage system received from the system outside the electricity storage system and the information on the states of the plurality of storage battery strings received from the plurality of first control units, and transmit the instruction value to the first control unit, and the first control unit is configured to control the auxiliary devices of the storage battery strings according to the instruction value of the charge and discharge power or the charge and discharge current of the storage battery string received from the second control unit.

The electricity storage system of the present invention is an electricity storage system including: a plurality of storage battery strings connected in parallel; and a storage battery control device, the storage battery string including a plurality of storage batteries connected in series, a plurality of bypass circuits that are provided respectively for the storage batteries and configured to switch the storage batteries between a bypass state and a connected state, and a power converter configured to convert input and output power of the storage battery string. In the electricity storage system, the storage battery control device includes a plurality of first control units that are provided respectively for the storage battery strings and configured to control auxiliary devices of the storage battery strings including the power converter and the bypass circuits, and a second control unit configured to communicate with the plurality of first control units and a system outside the electricity storage system, the first control unit is configured to acquire information on states of the storage battery strings and transmit the information to the second control unit, the second control unit is configured to calculate an instruction value of charge and discharge power or a charge and discharge current assigned to each of the plurality of storage battery strings based on an instruction value of charge and discharge power or a charge and discharge current of the electricity storage system received from the system outside the electricity storage system and the information on the states of the plurality of storage battery strings received from the plurality of first control units, and transmit the instruction value to the first control unit, and the first control unit is configured to control the auxiliary devices of the storage battery strings according to the instruction value of the charge and discharge power or the charge and discharge current of the storage battery string received from the second control unit.

### Advantageous Effects of Invention

According to the present invention, an amount of stored power can be managed in a unit of a storage battery string and a unit of a storage battery, and a processing load of a control device can be appropriately prevented even in a large-scale electricity storage system.

### BRIEF DESCRIPTION OF DRAWINGS

FIG. 1 is a perspective view showing an electricity storage system including a storage battery control device according to an embodiment of the present invention.

FIG. 2 is a perspective view showing a string included in the electricity storage system shown in FIG. 1.

FIG. 3 is a circuit diagram showing a configuration of a circuit of the electricity storage system shown in FIG. 1.

FIG. 4 is a block diagram showing a configuration of a control of the electricity storage system shown in FIG. 1.

FIG. 5 is a flowchart for illustrating a process of an electricity storage system controller.

FIG. 6 is a flowchart for illustrating a process of a string system controller.

FIG. 7 is a flowchart for illustrating a process of a string controller.

FIG. 8 is a flowchart for illustrating a process of the string controller.

FIG. 9 is a flowchart for illustrating a process of the string controller.

FIG. 10 is a flowchart for illustrating a process of a module controller.

### DESCRIPTION OF EMBODIMENTS

Hereinafter, the present invention will be described with reference to a preferred embodiment. The present invention is not limited to the embodiment to be described below, and the embodiment can be appropriately modified without departing from the gist of the present invention. In the embodiment to be described below, a part of configurations may be not described or shown in the drawings, and regarding the details of the omitted techniques, publicly known or well-known techniques will be appropriately applied as long as there is no contradiction with the contents to be described below.

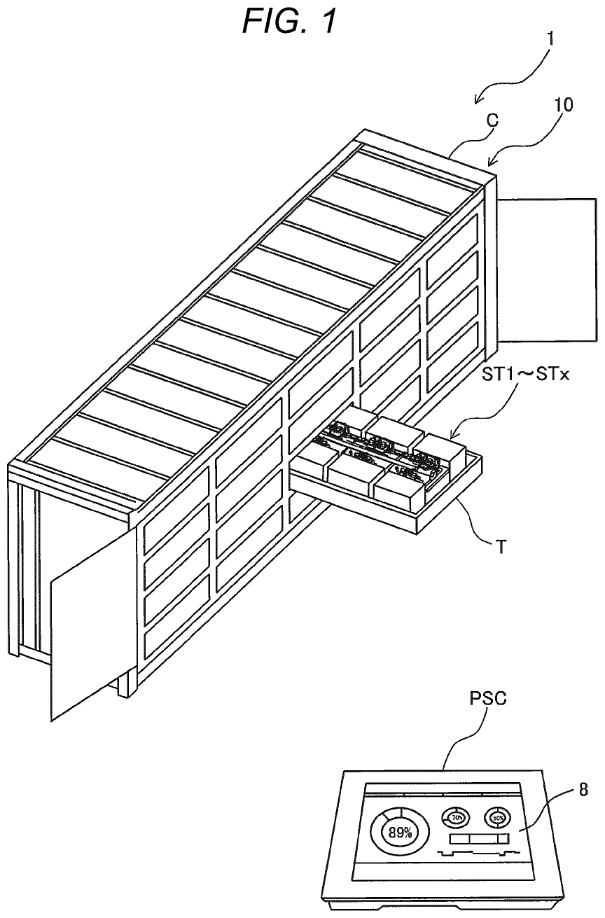

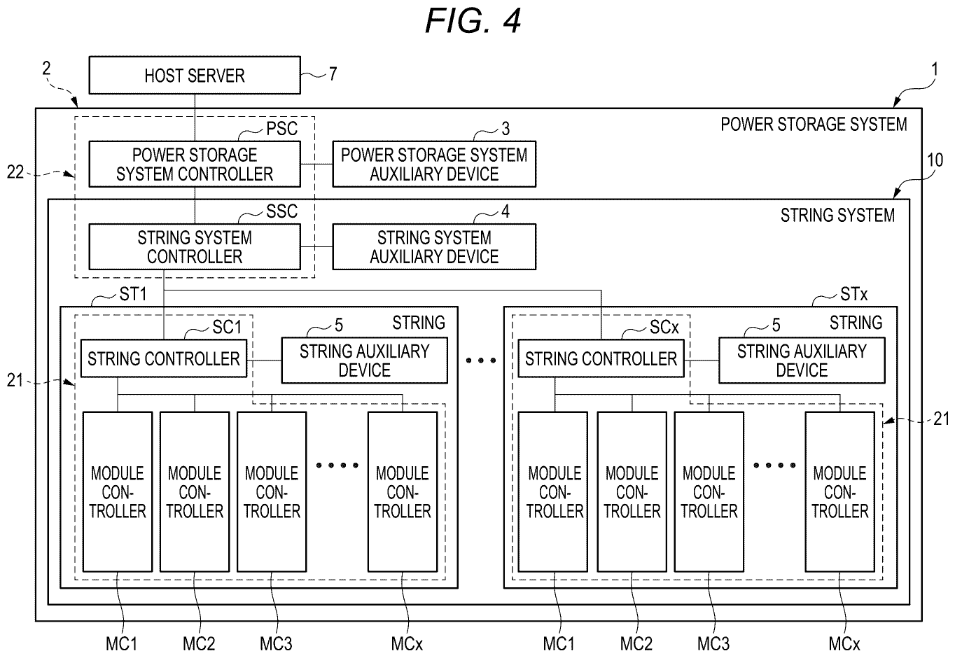

FIG. 1 is a perspective view showing an electricity storage system 1 including a storage battery control device 2 (see FIG. 4) according to an embodiment of the present invention. As shown in this drawing, the electricity storage system 1 is a stationary power supply, and includes a string system 10, a container C that accommodates the string system 10, and an electricity storage system controller PSC. The string system 10 includes a large number of strings ST1 to STx.

The container C accommodates a large number of trays T arranged vertically and horizontally such that the trays T can be pulled out. The string ST1 to STx are placed on each tray T. The electricity storage system controller PSC is a control device that communicates with a host server 7 and a string system controller SSC that are to be described later and controls an electricity storage system auxiliary device 3 (see FIG. 4). The electricity storage system controller PSC includes a display input device 8 such as a touch panel having a display function and an input function. The host server 7, the electricity storage system auxiliary device 3, and the string system controller SSC will be described later.

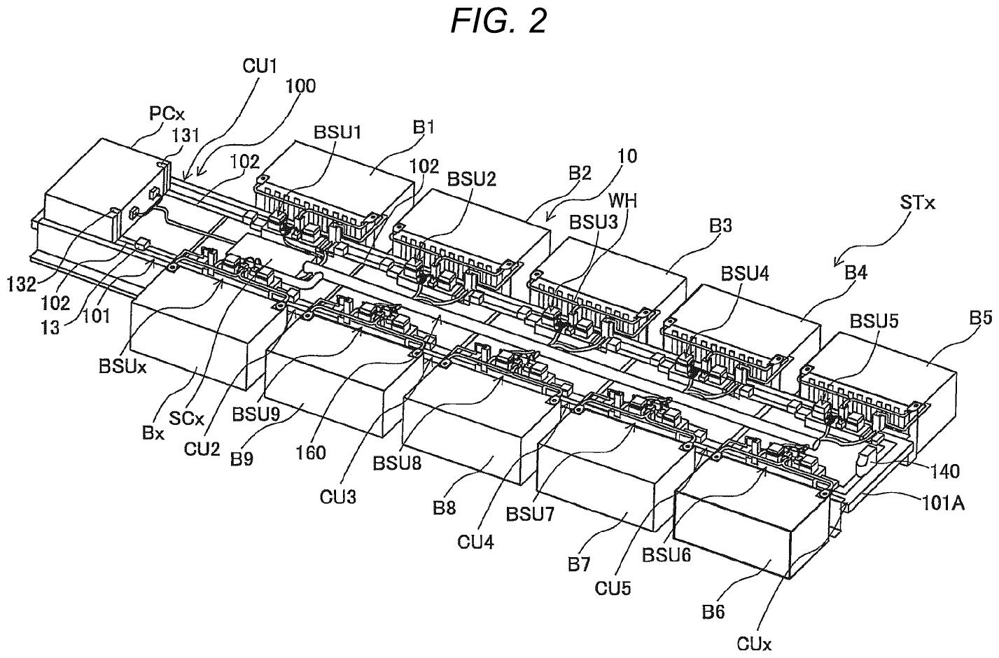

FIG. 2 is a perspective view showing the string STx included in the electricity storage system 1 shown in FIG. 1. As shown in this drawing, the string STx includes a large number of storage batteries B1 to Bx and a storage battery connection module 100.

The string STx includes the large number of storage batteries B1 to Bx connected in series. Although not particularly limited, the storage batteries B1 to Bx of the present embodiment are obtained by recycling used storage batteries, and the storage batteries B1 to Bx differ in a degree of deterioration. The storage batteries B1 to Bx each include a positive electrode terminal and a negative electrode terminal to which a wire harness WH for power supply is connected. The storage batteries B1 to Bx are secondary batteries such as a lithium ion battery and a lithium ion capacitor, are charged by being supplied with power from an external system (not shown) through a power converter PCx, and discharge the charged power through the power converter PCx to supply power to the external system. The external system includes a household electrical appliance, a load such as a commercial power supply system, and a power generator such as a solar photovoltaic system.

The storage batteries B1 to Bx are storage battery modules in which a large number of storage battery cells are connected in series. The storage batteries B1 to Bx each may be a storage battery pack in which a plurality of storage battery modules are connected in series, or may be a single storage battery cell.

The storage batteries B1 to Bx are arranged in two rows, and the storage battery connection module 100 is disposed between the rows. The storage battery connection module 100 includes a base plate 101, a plurality of bypass switch units BSU1 to BSUx, and a plurality of busbars 102. In addition, the storage battery connection module 100 includes a current sensor 13, the power converter PCx, a service plug 140, and a string controller SCx. Further, the storage battery connection module 100 includes a wire harness unit 160 for communication and power supply and the wire harness WH for power supply.

On the other hand, the storage battery connection module 100 includes a plurality of connection units CU1 to CUx linearly arranged. The leading connection unit CU1 is provided with the power converter PCx and the current sensor 13. Following the connection unit CU1, the connection units CU2 to CUx are arranged in order.

The storage battery connection module 100 includes the plurality of bypass switch units BSU1 to BSUx. The bypass switch units BSU1 to BSUx are provided respectively for the storage batteries B1 to Bx. In addition, the plurality of bypass switch units BSU1 to BSUx are provided in any of the connection units CU2 to CUx in pairs of two bypass switch units.

While the storage batteries B1 to Bx are arranged in order of B1, B2, . . . , and Bx in a connection direction of the storage batteries B1 to Bx, the bypass switch units BSU1 to BSUx are arranged in order of BSU1, BSU2, . . . , and BSUx in the connection direction of the storage batteries B1 to Bx. The bypass switch unit BSU1 is connected to the positive electrode terminal and the negative electrode terminal of the storage battery B1 by the wire harness WH for power supply. In addition, the bypass switch unit BSU1 is connected to a connection terminal (not shown) for communication and power supply of the storage battery B1 by a wire harness (not shown) for communication and power supply. Similarly, each of the bypass switch units BSU2 to BSUx is connected to the positive electrode terminal and the negative electrode terminal of each of the storage batteries B2 to Bx by the wire harness WH for power supply, and is connected to a connection terminal for communication and power supply of each of the storage batteries B2 to Bx by the wire harnesses for communication and power supply. The bypass switch units BSU1 to BSUx have the same configuration. The configuration of the bypass switch units BSU1 to BSUx will be described in detail later.

The power converter PCx is, for example, a bidirectional DC/DC converter, and includes a positive electrode terminal 131 on a primary side during discharge, a negative electrode terminal 132 on the primary side during discharge, a positive electrode terminal (not shown) on a secondary side during discharge, and a negative electrode terminal (not shown) on the secondary side during discharge. The positive electrode terminal 131 is connected to an input terminal of the bypass switch unit BSU1 of the connection unit CU2 by the busbar 102. The negative electrode terminal 132 is connected to the current sensor 13 by the busbar 102. The current sensor 13 is connected to an output terminal of the bypass switch unit BSUx of the connection unit CU2 by the busbar 102.

An output terminal of the bypass switch unit BSU1 and an input terminal of the bypass switch unit BSU2 are connected by the busbar 102. Similarly, among the plurality of bypass switch units BSU2 to BSUx, those adjacent to each other in the connection direction of the storage batteries B1 to Bx are connected by the busbar 102. Here, among the plurality of bypass switch units BSU1 to BSUx, those adjacent to each other in the connection direction of the storage batteries B1 to Bx are mechanically connected by the busbar 102, so that the base plate 101 in which a plurality of plates 101A are integrated is formed.

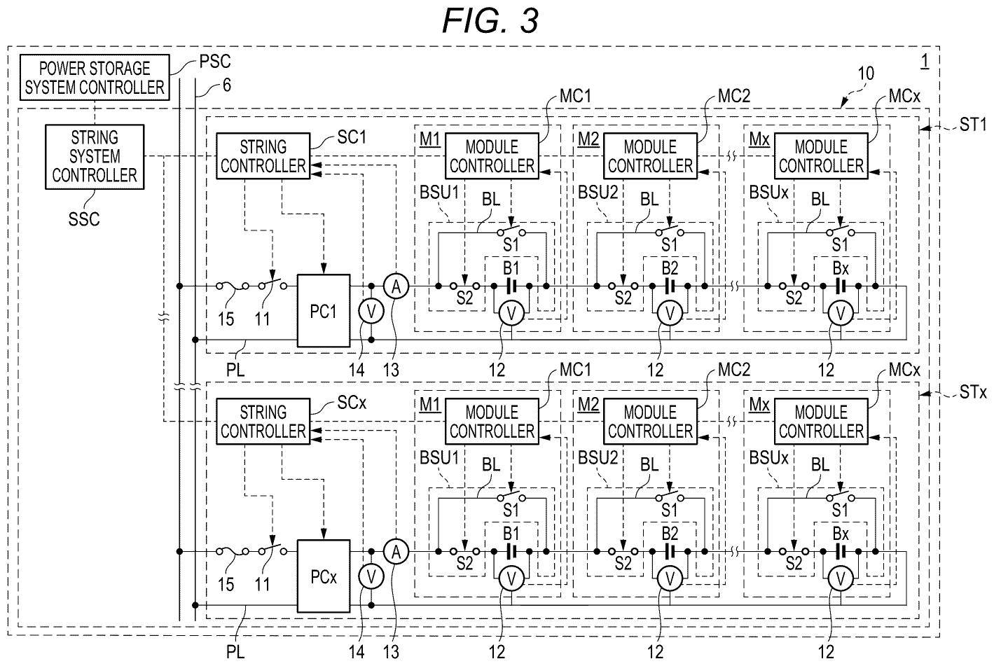

FIG. 3 is a circuit diagram showing a configuration of a circuit of the electricity storage system 1 shown in FIG. 1. As shown in this drawing, the electricity storage system 1 includes the electricity storage system controller PSC and the string system 10. In the present embodiment, a single string system 10 is provided, but a plurality of string systems 10 may be provided.

The string system 10 includes the string system controller SSC, the large number of strings ST1 to STx, and a string bus 6. The large number of strings ST1 to STx are connected in parallel to each other via the string bus 6 and are connected to an external system (not shown).

Each of the strings ST1 to STx includes one of the string controllers SC1 to SCx, one of power converters PC1 to PCx, one string interruption switch 11, and a large number of modules M1 to Mx. Each of the modules M1 to Mx includes one of the storage batteries B1 to Bx, one of the bypass switch units BSU1 to BSUx, one voltage sensor 12, and one of the module controllers MC1 to MCx. Here, each of the strings ST1 to STx includes the large number of storage batteries B1 to Bx connected in series and the large number of bypass switch units BSU1 to BSUx provided respectively for the storage batteries B1 to Bx. In addition, each of the strings ST1 to STx includes one current sensor 13, one voltage sensor 14, one fuse 15, the same number of voltage sensors 12 and temperature sensors (not shown) as the storage batteries B1 to Bx, and the same number of cell voltage sensors (also not shown) as the storage battery cells.

The power converters PC1 to PCx are bidirectional converters and are connected to the string bus 6. In the power converters PC1 to PCx, a positive electrode of the storage battery B1 at a starting end and a negative electrode of the storage battery Bx at a terminal end are connected.

During charge of the strings ST1 to STx, the power converters PC1 to PCx convert a voltage input from the string bus 6 according to an instruction value of charge power (or charge current) (hereinafter, referred to as charge power instruction value) to be described later and output the converted voltage to the plurality of storage batteries B1 to Bx. Here, a voltage on a side of the strings ST1 to STx changes according to a bypass state (the number of bypassed storage batteries B1 to Bx) of the storage batteries B1 to Bx and a charge state of the storage batteries B1 to Bx. Therefore, during the charge of the strings ST1 to STx, the power converters PC1 to PCx convert the voltage input from the string bus 6 into the voltage on the side of the strings ST1 to STx and output the converted voltage to the plurality of storage batteries B1 to Bx.

During discharge of the strings ST1 to STx, the power converters PC1 to PCx convert voltages input from the plurality of storage batteries B1 to Bx according to an instruction value of discharge power (or discharge current) (hereinafter, referred to as discharge power instruction value) to be described later and output the converted voltages to the string bus 6. Here, input voltages of the power converters PC1 to PCx during discharge change according to the bypass state of the storage batteries B1 to Bx and the charge state of the storage batteries B1 to Bx. This causes variations in the input voltages of the power converters PC1 to PCx among the strings ST1 to STx during discharge. Therefore, during the discharge of the strings ST1 to STx, the power converters PC1 to PCx convert the input voltages into voltages that match other strings ST1 to STx and output the converted voltages to the string bus 6. In a case where a current flowing through the string bus 6 is an alternating current, each of the power converters PC1 to PCx includes a synchronization unit for following a change in an instantaneous value.

The string interruption switch 11 is provided between each of the power converters PC1 to PCx and the string bus 6. The string interruption switch 11 connects or interrupts the strings ST1 to STx to or from the string bus 6. The fuse 15 is a power fuse provided between the string interruption switch 11 and the string bus 6.

The voltage sensor 12 is connected between the positive and negative electrode terminals of each of the storage batteries B1 to Bx, detects a voltage between the terminals of each of the storage batteries B1 to Bx, and transmits a detection signal to each of the module controllers MC1 to MCx. The current sensor 13 is provided on a power line PL of each of the strings ST1 to STx, detects a charge and discharge current of each of the strings ST1 to STx (hereinafter, referred to as string current), and transmits a detection signal to each of the string controllers SC1 to SCx. The voltage sensor 14 is provided on the power line PL of each of the strings ST1 to STx, detects a total voltage of each of the strings ST1 to STx (hereinafter, referred to as string total voltage), and transmits a detection signal to each of the string controllers SC1 to SCx. The temperature sensor is provided in each of the storage batteries B1 to Bx, detects a temperature of each of the storage batteries B1 to Bx, and transmits a detection signal to each of the module controllers MC1 to MCx. Further, the cell voltage sensors are provided respectively for storage battery cells of each of the storage batteries B1 to Bx, detect a voltage of the storage battery cell, and transmit a detection signal to each of the module controllers MC1 to MCx.

The bypass switch units BSU1 to BSUx are provided respectively for the storage batteries B1 to Bx. Each of the bypass switch units BSU1 to BSUx includes a bypass line BL and switches S1 and S2. The bypass line BL is a power line that bypasses each of the storage batteries B1 to Bx. The switch S1 is provided on the bypass line BL. The switch S1 is, for example, a mechanical switch, a semiconductor switch, or a relay. The switch S2 is provided between the positive electrode of each of the storage batteries B1 to Bx and one end of the bypass line BL. The switch S2 is, for example, a mechanical switch, a semiconductor switch, or a relay.

The storage battery B1 at the starting end and the storage battery Bx at the terminal end are connected to the external system (not shown) via the power converters PC1 to PCx and the string bus 6. In a case where the switch S1 is turned off and the switch S2 is turned on in all the bypass switch units BSU1 to BSUx, all the storage batteries B1 to Bx are connected in series to the external system. On the other hand, in a case where the switch S2 is turned off and the switch S1 is turned on in any of the bypass switch units BSU1 to BSUx, the storage batteries B1 to Bx corresponding to the bypass switch units BSU1 to BSUx are bypassed.

FIG. 4 is a block diagram showing a configuration of a control of the electricity storage system 1 shown in FIG. 1. As shown in this drawing, the electricity storage system 1 includes the storage battery control device 2. The storage battery control device 2 includes a plurality of first control devices 21 and a second control device 22. The first control device 21 includes the large number of string controllers SC1 to SCx and further the large number of module controllers MC1 to MCx. The second control device 22 includes the electricity storage system controller PSC and the string system controller SSC.

The electricity storage system controller PSC, the string system controller SSC, the string controllers SC1 to SCx, and the module controllers MC1 to MCx are provided respectively for hierarchies. The electricity storage system controller PSC corresponds to the hierarchy of the electricity storage system 1 of a highest order. The string system controller SSC corresponds to the hierarchy of the string system 10 subsequent to the hierarchy of the electricity storage system 1. The string controllers SC1 to SCx correspond to the hierarchy of the strings ST1 to STx subsequent to the hierarchy of the string system 10. The module controllers MC1 to MCx correspond to the hierarchy of the modules M1 to Mx (see FIG. 3) subsequent to the hierarchy of the strings ST1 to STx. The controller corresponding to each hierarchy will be described below.

### <Electricity Storage System Controller PSC>

The electricity storage system controller PSC communicates with the host server 7 and the string system controller SSC and controls and manages the electricity storage system auxiliary device 3. The host server 7 is provided in a facility of an aggregator, a power receiving facility such as a building or a factory, or the like. The host server 7 calculates an instruction value of charge and discharge power (or charge and discharge current) (hereinafter, referred to as charge and discharge power instruction value) for the entire electricity storage system 1 according to a state of the electricity storage system 1 and a power demand on a demand side, and transmits the instruction value to the electricity storage system controller PSC.

The electricity storage system auxiliary device 3 includes a temperature sensor that detects a temperature in the container C (see FIG. 1), an opening and closing sensor that detects opening and closing of a door of the container C, and a fire extinguishing system (all not shown). In a case where a detected value of the temperature sensor exceeds a threshold value, the electricity storage system controller PSC determines that the temperature in the container C is abnormal, and outputs an abnormality notification to the display input device 8 (see FIG. 1). In addition, in a case where the opening of the door is detected by the opening and closing sensor, the electricity storage system controller PSC outputs a notification of the door being open to a display panel. Further, the electricity storage system controller PSC monitors an operating state of the fire extinguishing system.

The electricity storage system controller PSC receives information on states of the strings ST1 to STx (hereinafter, referred to as string state information) and information on a state of the string system 10 (hereinafter, referred to as string system state information) from the string system controller SSC, and outputs the information to the host server 7 or the display panel.

The states of the strings ST1 to STx include operation states such as charge, discharge, pause, and maintenance, the string current, the string total voltage, a state of charge (SOC) of the strings ST1 to STx (hereinafter, referred to as string SOC), a state of health (SOH) of the strings ST1 to STx (hereinafter, referred to as string SOH), and a limit value of input and output currents (or input and output currents) of the strings ST1 to STx (hereinafter, referred to as string input and output power limit value).

The state of the string system 10 includes a current of the string bus 6 (see FIG. 3) (hereinafter, referred to as string bus current), a voltage of the string bus 6 (hereinafter, referred to as string bus voltage), a SOC of the string system 10 (hereinafter, referred to as string system SOC), a SOH of the string system 10 (hereinafter, referred to as string system SOH), and a limit value of input and output power (or input and output current) of the string system 10 (hereinafter, referred to as string system input and output power limit value).

The electricity storage system controller PSC estimates the state of the electricity storage system 1 based on the string state information and the string system state information received from the string system controller SSC. The state of the electricity storage system 1 includes operation states such as charge, discharge, pause, and maintenance, a SOC of the electricity storage system 1 (hereinafter, referred to as electricity storage system SOC), and a SOH of the electricity storage system 1 (hereinafter, referred to as electricity storage system SOH). The electricity storage system controller PSC outputs information on the estimated state of the electricity storage system 1 (hereinafter, referred to as electricity storage system state information) to the display panel as necessary. In the present embodiment in which a single string system 10 is provided, the string system SOC is equal to the electricity storage system SOC, and the string SOH is equal to the electricity storage system SOH.

The electricity storage system controller PSC transmits information required for a process of the host server 7 to the host server 7. The information required for the process of the host server 7 includes the electricity storage system SOC, the electricity storage system SOH, and the string system input and output power limit value. Here, the host server 7 determines a charge and discharge instruction corresponding to the electricity storage system 1 based on the “information required for the process of the host server 7” received from the electricity storage system controller PSC, and transmits the charge and discharge instruction to the electricity storage system controller PSC. The charge and discharge instruction includes, in addition to the charge and discharge power instruction value, a control amount in a constant voltage (CV) mode, a constant current (CC) mode, and a constant power (CP) mode, and an operation method such as a self-sustained operation or a system interconnection.

The electricity storage system controller PSC transmits various kinds of instruction information input by an operator or the like through the display input device 8 to the string system controller SSC. The various kinds of instruction information that can be input through the display input device 8 include information of an instruction to execute a maintenance and stop mode (hereinafter, referred to as maintenance and stop instruction), an instruction to forcibly execute charge and discharge, an instruction to forcibly execute state estimation, and the like.

The maintenance and stop instruction includes an instruction to forcibly cause the electricity storage system auxiliary device 3, the string system auxiliary device 4, and the string auxiliary device 5 to operate. By forcibly causing the electricity storage system auxiliary device 3, the string system auxiliary device 4, and the string auxiliary device 5 to operate, operation confirmations of the electricity storage system auxiliary device 3, the string system auxiliary device 4, and the string auxiliary device 5 can be executed.

The instruction to forcibly execute charge and discharge includes an instruction to specify a predetermined charge and discharge amount and forcibly cause the electricity storage system 1 to execute charge and discharge. By specifying the predetermined charge and discharge amount and forcibly causing the electricity storage system 1 to execute charge and discharge, whether the electricity storage system 1 can input and output the specified predetermined charge and discharge amount can be confirmed.

The instruction to forcibly execute the state estimation includes an instruction to specify an item of predetermined state estimation and forcibly cause the electricity storage system 1 to execute the state estimation. By specifying the item of the predetermined state estimation and forcibly causing the electricity storage system 1 to execute the state estimation, for example, the item of the state estimation such as the string system SOH and the electricity storage system SOH can be acquired at any time point.

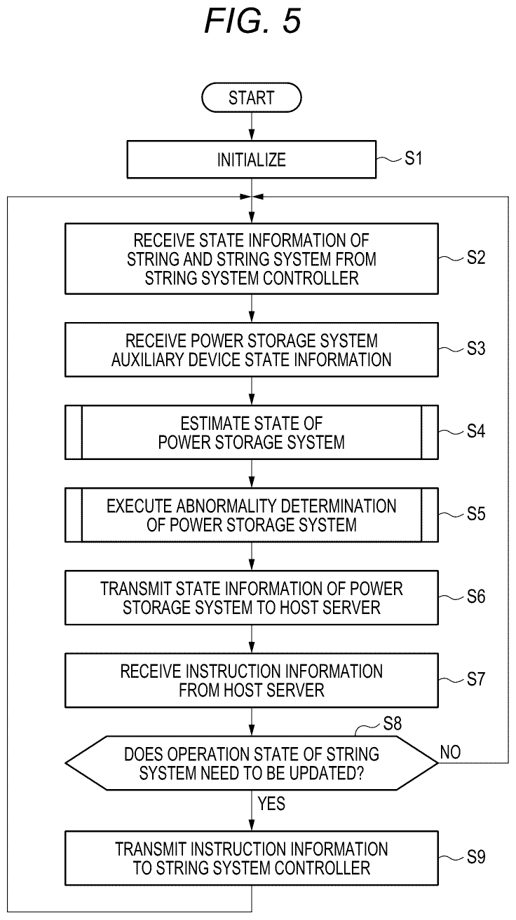

FIG. 5 is a flowchart for illustrating a process of the electricity storage system controller PSC. The process illustrated in the flowchart is started and proceeds to step S1 when the electricity storage system 1 is operated, and steps S2 to S9 are repeated while the electricity storage system 1 is operated.

In step S1, the electricity storage system controller PSC initializes various parameters. Next, in step S2, the electricity storage system controller PSC receives the string state information and the string system state information from the string system controller SSC. The electricity storage system controller PSC outputs the string state information and the string system state information to the display input device 8 as necessary.

Next, in step S3, the electricity storage system controller PSC acquires information on a state (temperature of container C, open and closed state of door, and the like) of the electricity storage system auxiliary device 3 (hereinafter, referred to as electricity storage system auxiliary device state information) from the electricity storage system auxiliary device 3. The electricity storage system controller PSC outputs the electricity storage system auxiliary device state information to the display input device 8 as necessary.

Next, in step S4, the electricity storage system controller PSC estimates the state of the electricity storage system 1 based on the string state information and the string system state information received in step S2. The electricity storage system controller PSC outputs information on the state of the electricity storage system (hereinafter, referred to as electricity storage system state information) to the display input device 8 as necessary. The estimation of the state of the electricity storage system 1 may be executed by the string system controller SSC. In this case, the string system controller SSC may transmit an estimation result to the electricity storage system controller PSC.

Next, in step S5, the electricity storage system controller PSC analyzes the information acquired in steps S2 to S4 and determines whether there is an abnormality in the electricity storage system 1. The electricity storage system controller PSC determines whether there is an abnormality in the electricity storage system 1 by, for example, comparing various detected values or estimated values received in steps S2 to S4 with a threshold value. The electricity storage system controller PSC outputs a determination result regarding whether there is an abnormality in the electricity storage system 1 to the display input device 8 as necessary.

Next, in step S6, the electricity storage system controller PSC transmits information required for the process of the host server 7 among the information acquired in steps S2 to S5 to the host server 7. Next, in step S7, the electricity storage system controller PSC receives instruction information such as the charge and discharge power instruction value transmitted from the host server 7. Here, the host server 7 determines an instruction corresponding to the electricity storage system 1 based on the information received from the electricity storage system controller PSC in step S6, and transmits the instruction information such as the charge and discharge power instruction value to the electricity storage system controller PSC in step S7.

Next, in step S8, the electricity storage system controller PSC compares the current and previous instruction information received from the host server 7, and determines whether an operation state of the string system 10 needs to be updated. For example, in a case where charge and discharge power values received from the host server 7 change between the previous time and the current time, the electricity storage system controller PSC determines that the operation state of the string system 10 needs to be updated. In a case where the determination in step S8 is YES, the process proceeds to step S9, and in a case where the determination in step S8 is NO, the process proceeds to step S2.

In step S9, the electricity storage system controller PSC transmits the instruction information such as the charge and discharge power instruction value received in step S7 to the string system controller SSC. The process proceeds from step S9 to step S2. Thereafter, steps S2 to S9 are repeated during the operation of the electricity storage system 1.

### <String System Controller SSC>

The string system controller SSC shown in FIG. 4 communicates with the electricity storage system controller PSC and the large number of string controllers SC1 to SCx, and controls and manages the string system auxiliary device 4. The string system auxiliary device 4 includes a temperature sensor that detects an atmospheric temperature, a cooling device in the string system 10, an interruption device of the string bus 6, a current sensor that detects a current of the string bus 6, and a voltage sensor that detects a voltage of the string bus 6.

The string system controller SSC receives the string state information from the string controllers SC1 to SCx. The states of the strings ST1 to STx include operation states such as charge, discharge, pause, and maintenance, the string current, the string total voltage, the string SOC, the string SOH, the string charge and discharge power limit value, and the state of the string system auxiliary device 4. The state of the string system auxiliary device 4 includes the string bus current and the string bus voltage.

The string system controller SSC estimates the state of the string system 10 based on the string state information received from the string controllers SC1 to SCx. The state of the string system 10 includes the string bus current, the string bus voltage, the string system SOC, the string system SOH, and the string system input and output power limit value. The estimation of the state of the string system 10 may be executed by the electricity storage system controller PSC. The electricity storage system controller PSC may receive the string state information from the string system controller SSC to estimate the state of the string system 10, and estimate the state of the electricity storage system 1 based on an estimation result thereof.

For example, in a case where detected values of the temperature sensor, the current sensor, and the voltage sensor or an estimated value of the state of the string system 10 exceeds a range of the threshold value, the string system controller SSC determines whether there is an abnormality in the string system 10, stops the operation of the string system 10, and transmits an abnormality notification to the electricity storage system controller PSC.

The string system controller SSC transmits, to the electricity storage system controller PSC, information required for a process of the electricity storage system controller PSC among the information received from the string controllers SC1 to SCx and the information estimated by the string system controller SSC. The information required for the process of the electricity storage system controller PSC includes the string system SOC, the string system SOH, and the string system input and output power limit value.

Here, the electricity storage system controller PSC determines an instruction corresponding to the string system 10 based on the “information required for the process of the electricity storage system controller PSC” received from the string system controller SSC, and transmits instruction information to the string system controller SSC. The instruction includes a charge and discharge instruction for the string system 10 in a charge and discharge mode, an instruction to individually control each unit of the string system 10 in a maintenance mode (hereinafter, referred to as individual control instruction), and a state estimation instruction for the string system 10 in a state estimation mode. The charge and discharge instruction of the string system 10 in the charge and discharge mode includes, in addition to the charge and discharge power instruction value, the control amount in the constant voltage (CV) mode, the constant current (CC) mode, and the constant power (CP) mode, and the operation method such as a self-sustained operation or a system interconnection. The individual control instruction of the string system 10 in the maintenance mode includes an instruction to individually control the string system auxiliary device 4 such as the power converters PC1 to PCx, the cooling device (not shown), and the switches S1 and S2. The state estimation instruction for the string system 10 in the state estimation mode includes an execution instruction of a predetermined control required for executing the state estimation of each of the strings ST1 to STx.

The string system controller SSC receives the instruction corresponding to the above-described string system 10 from the electricity storage system controller PSC, and determines whether the operation state of the string system 10 needs to be updated by comparing the currently received instruction with the previously received instruction. In a case where it is determined that the operation state of the string system 10 needs to be updated, the string system controller SSC determines an operation mode of each of the strings ST1 to STx, permission for a bypass request from each of the string controllers SC1 to SCx (hereinafter, referred to as bypass permission), and a charge and discharge power instruction value assigned to each of the strings ST1 to STx. The operation mode of each of the strings ST1 to STx includes the charge and discharge mode, the state estimation mode, the maintenance and stop mode, and the like.

Here, the string system controller SSC determines the operation mode of each of the strings ST1 to STx, the bypass permission, and the charge and discharge power instruction value based on an operation history of each of the strings ST1 to STx from the past to the present. The determination of the operation mode or the like based on the operation history from the past to the present includes the following (1) to (4). (1) Determine whether to execute the state estimation of each of the strings ST1 to STx based on an execution timing of the state estimation of each of the strings ST1 to STx. (2) Determine whether to execute maintenance of each of the strings ST1 to STx or to execute charge and discharge of each of the strings ST1 to STx based on whether abnormality determination of each of the strings ST1 to STx is executed and a timing thereof. (3) Determine the charge and discharge power instruction value of each of the strings ST1 to STx according to whether there is a bypass request from each of the string controllers SC1 to SCx. For example, determine the charge and discharge power instruction value of the strings ST1 to STx corresponding to the string controllers SC1 to SCx from which the bypass request is transmitted to be 0. After a bypass control of the strings ST1 to STx is completed, increase the charge and discharge power instruction value for the strings ST1 to STx. (4) Determine the charge and discharge power instruction value of each of the strings ST1 to STx based on the string SOC, the string SOH, and the string total voltage of each of the strings ST1 to STx.

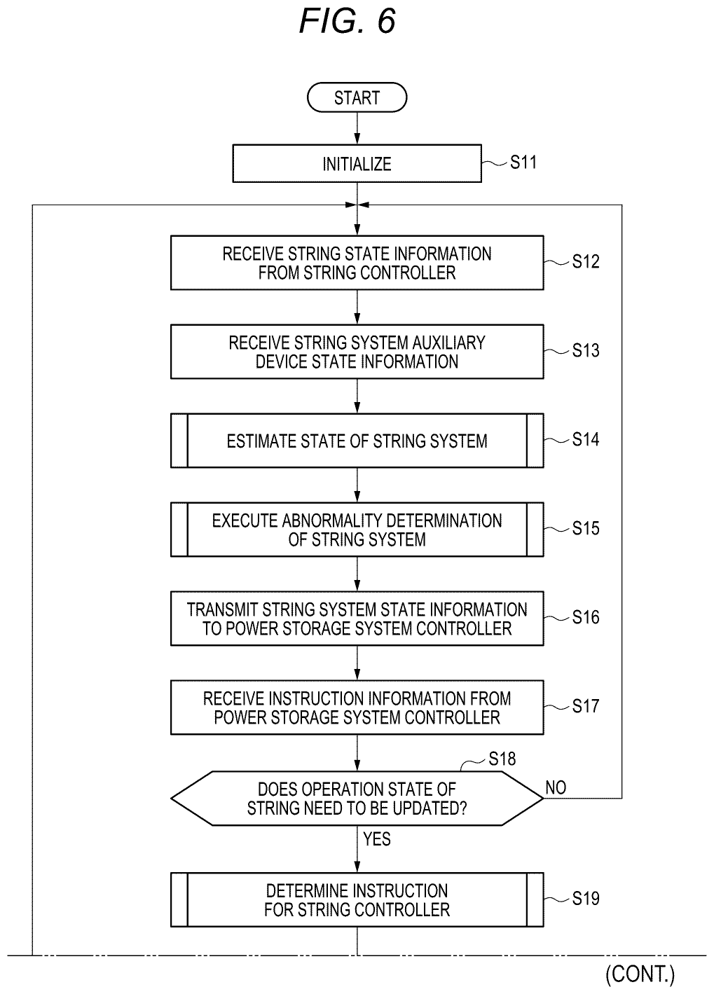

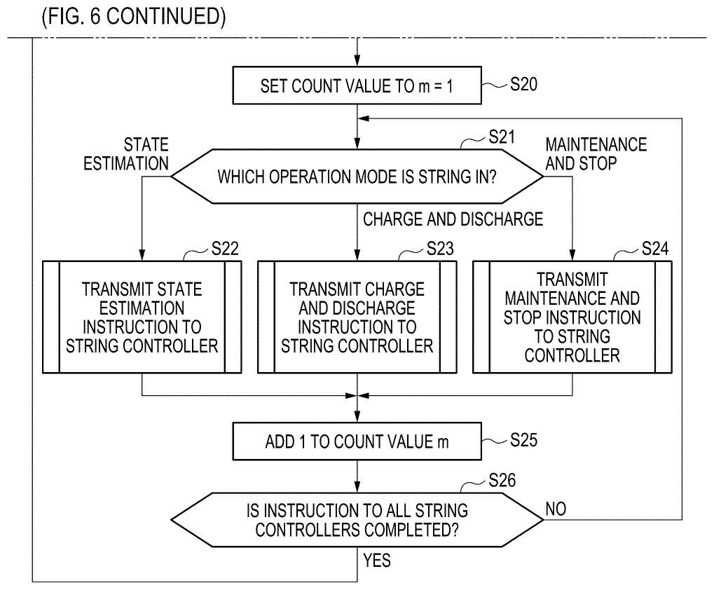

FIG. 6 is a flowchart for illustrating a process of the string system controller SSC. The process illustrated in the flowchart is started and proceeds to step S11 when the electricity storage system 1 is operated, and steps S12 to S26 are repeated while the electricity storage system 1 is operated.

In step S11, the string system controller SSC initializes various parameters. Next, in step S12, the string system controller SSC receives the string state information from each of the string controllers SC1 to SCx.

Next, in step S13, the string system controller SSC receives string system auxiliary device state information (string bus voltage, string bus current, and the like) from the string system auxiliary device 4.

Next, in step S14, the string system controller SSC estimates the state of the string system 10 based on the string state information received in step S12 and the string system auxiliary device state information received in step S13. The estimation of the state of the string system 10 may be executed by the electricity storage system controller PSC, and an estimation result thereof may be transmitted from the electricity storage system controller PSC to the string system controller SSC or the host server 7.

Next, in step S15, the string system controller SSC analyzes the information received in steps S12 to S14 and determines whether there is an abnormality in the string system 10. The string system controller SSC determines whether there is an abnormality in the string system 10 by, for example, comparing various detected values or estimated values received in steps S12 to S14 with a threshold value.

Next, in step S16, the string system controller SSC transmits, to the electricity storage system controller PSC, information required for the processes of the electricity storage system controller PSC and the host server 7 among the information received in steps S12 to S15. Next, in step S17, the string system controller SSC receives an instruction transmitted from the electricity storage system controller PSC. Here, the electricity storage system controller PSC determines the instruction corresponding to the string system 10 (charge and discharge power instruction value in charge and discharge mode) based on the information received from the string system controller SSC in step S16, and transmits the instruction to the string system controller SSC in step S17.

Next, in step S18, the string system controller SSC compares the current and previous instructions received from the electricity storage system controller PSC, and determines whether operation states of the strings ST1 to STx need to be updated. For example, in a case where charge and discharge power instruction values received from the electricity storage system controller PSC change between the previous time and the current time, the string system controller SSC determines that the operation states of the strings ST1 to STx need to be updated. In addition, for example, in a case where individual control instructions in the maintenance mode received from the electricity storage system controller PSC change between the previous time and the current time, the string system controller SSC determines that the operation states of the strings ST1 to STx need to be updated. In a case where the determination in step S18 is YES, the process proceeds to step S19, and in a case where the determination in step S18 is NO, the process proceeds to step S12.

Next, in step S19, the string system controller SSC determines an instruction for each of the string controllers SC1 to SCx according to a predetermined condition. The predetermined condition includes the state of each of the strings ST1 to STx acquired in step S12, the operation history of each of the strings ST1 to STx from the past to the present, and various instructions input through the display input device 8. An item of the instruction for each of the string controllers SC1 to SCx includes the operation mode (state estimation mode, charge and discharge mode, maintenance and stop mode, and the like) of each of the strings ST1 to STx, permission and non-permission for the bypass request from each of the string controllers SC1 to SCx, and assignment of the charge and discharge power instruction value to each of the strings ST1 to STx. In a case where the maintenance and stop instruction is input through the display input device 8, the string system controller SSC determines the instruction for each of the strings ST1 to STx to be the maintenance and stop instruction. Similarly, in a case where the instruction to forcibly execute charge and discharge or state estimation is input through the display input device 8 of the electricity storage system controller PSC, the string system controller SSC determines the instruction for each of the strings ST1 to STx to be the charge and discharge instruction or the state estimation instruction.

Next, in step S20, the string system controller SSC sets a count value m for managing transmission of instruction information for the string controllers SC1 to SCx to an initial value (m=1). Next, in step S21, the string system controller SSC determines whether the operation mode of the strings ST1 to STx to be instructed is any of the charge and discharge mode, the state estimation mode, and the maintenance and stop mode. In the case of the charge and discharge mode, the process proceeds to step S23, in the case of the state estimation mode, the process proceeds to step S22, and in the case of the maintenance and stop mode, the process proceeds to step S24.

In step S22, the string system controller SSC transmits the state estimation instruction to the string controllers SC1 to SCx to be instructed. An item of the state estimation instruction includes ON of a state estimation mode flag, the charge and discharge power instruction value, and bypass permission and non-permission. In the state estimation mode of each of the strings ST1 to STx, for example, discharge is executed with a constant current, and data such as a voltage is acquired during the discharge. Here, in a case where there is a variation in the degree of deterioration of the storage batteries B1 to Bx in each of the strings ST1 to STx, the storage batteries B1 to Bx reach a full discharge state in descending order of the degree of deterioration. Each time the storage batteries B1 to Bx reach the full discharge state, a bypass request is transmitted from the module controllers MC1 to MCx. Accordingly, the string system controller SSC determines whether to notify a bypass permission in response to the received bypass request, and transmits a notification of bypass permission and non-permission to the string controllers SC1 to SCx.

On the other hand, in step S23, the string system controller SSC transmits the charge and discharge instruction to the string controllers SC1 to SCx to be instructed. An item of the charge and discharge instruction includes ON of a charge and discharge mode flag, the charge and discharge power instruction value, and the bypass permission and non-permission. In a case where fully discharged or fully charged storage batteries B1 to Bx are present, the bypass request is transmitted from the module controllers MC1 to MCx. Accordingly, the string system controller SSC determines whether to notify a bypass permission in response to the received bypass request, and transmits a notification of bypass permission and non-permission to the string controllers SC1 to SCx.

On the other hand, in step S24, the string system controller SSC transmits the maintenance and stop instruction to the string controllers SC1 to SCx to be instructed. An item of the maintenance and stop instruction includes ON of a maintenance and stop flag, various instructions, and the bypass permission and non-permission. The various instructions are instructions corresponding to the instructions input through the display input device 8. Examples of the instructions include an instruction to forcibly cause the electricity storage system auxiliary device 3, the string system auxiliary device 4, the string auxiliary device 5, and the bypass switch units BSU1 to BSUx to operate. Here, in a case where the instruction to forcibly cause the bypass switch units BSU1 to BSUx to operate is input through the display input device 8, the string system controller SSC transmits an instruction of bypass permission and non-permission to the string controllers SC1 to SCx. The maintenance and stop instruction is not limited to the case of being input through the display input device 8, and may be transmitted when an abnormality occurs or may be periodically transmitted.

The process proceeds from steps S22, S23, and S24 to step S25, and in step S25, the string system controller SSC adds 1 to the count value m for managing the transmission of the instruction information to the string controllers SC1 to SCx. Next, in step S26, the string system controller SSC determines whether the transmission of the instruction information to all the string controllers SC1 to SCx is completed. Specifically, the string system controller SSC determines whether the count value m reaches the total number x of the string controllers SC1 to SCx. In a case where the determination in step S26 is NO, the process proceeds to step S21, and steps S21 to S26 are repeated. On the other hand, in a case where the determination in step S26 is YES, the process proceeds to step S12, and steps S12 to S26 are repeated during the operation of the electricity storage system 1.

### <String Controllers SC1 to SCx>

The string controllers SC1 to SCx shown in FIG. 4 communicate with the string system controller SSC and the large number of module controllers MC1 to MCx, and control and manage the string auxiliary device 5. The string auxiliary device 5 includes the power converters PC1 to PCx, the current sensor 13 that detects the string current, the voltage sensor 14 that detects the string total voltage, and the string interruption switch 11 (see FIG. 3 for all).

The string controllers SC1 to SCx receive information on states of the storage batteries B1 to Bx (hereinafter, referred to as storage battery state information) from the module controllers MC1 to MCx. The states of the storage batteries B1 to Bx include a temperature, a current, a voltage, and a cell voltage of the storage batteries B1 to Bx, states of the bypass switch units BSU1 to BSUx, and the like.

The string controllers SC1 to SCx estimate a SOC, a SOH, an input and output power limit value, and the like of the storage batteries B1 to Bx based on the storage battery state information received from the module controllers MC1 to MCx. The estimation of the SOC, the SOH, the input and output power limit value, and the like of the storage batteries B1 to Bx may be executed by the module controllers MC1 to MCx. In this case, the module controllers MC1 to MCx may transmit an estimation result thereof to the string controllers SC1 to SCx.

The string controllers SC1 to SCx estimate the states of the strings ST1 to STx based on the storage battery state information received from the module controllers MC1 to MCx. The states of the strings ST1 to STx include the string SOH, the string SOC, and an input and output power limit value of the strings ST1 to STx (hereinafter, referred to as string input and output power limit value). The estimation of the states of the strings ST1 to STx may be executed by the string system controller SSC. In this case, the string controllers SC1 to SCx may transmit the storage battery state information and an estimation result of the state of the storage battery to the string system controller SSC.

For example, in a case where detected values of the current sensor 13 and the voltage sensor 14 or estimated values of the states of the strings ST1 to STx are out of a range of the threshold value, the string controllers SC1 to SCx determine whether there is an abnormality in the strings ST1 to STx. In this case, the string controllers SC1 to SCx stop the operation of the strings ST1 to STx or transmit an abnormality notification to the string system controller SSC.

The string controllers SC1 to SCx transmit, to the string system controller SSC, information required for the process of the string system controller SSC among the information received from the module controllers MC1 to MCx and the information estimated by the string controllers SC1 to SCx. The information required for the process of the string system controller SSC includes the temperature, the current, the voltage, the SOC, the SOH, the input and output power limit value, and the cell voltage of the storage batteries B1 to Bx, the states of the bypass switch units BSU1 to BSUx, the string SOC, the string SOH, and the string input and output power limit value.

Here, the string system controller SSC determines an instruction corresponding to each of the strings ST1 to STx based on the “information required for the process of the string system controller SSC” received from the string controllers SC1 to SCx, and transmits instruction information to the string controllers SC1 to SCx. The instruction includes a charge and discharge instruction of each of the strings ST1 to STx in the charge and discharge mode, an individual control instruction of each of the strings ST1 to STx in the maintenance mode, and a state estimation instruction of each of the strings ST1 to STx in the state estimation mode. An item of the charge and discharge instruction of each of the strings ST1 to STx in the charge and discharge mode includes, in addition to the charge and discharge power instruction value, the control amount in the constant voltage mode, the constant current mode, and the constant power mode, and the operation method such as a self-sustained operation or a system interconnection. An item of the individual control instruction of each of the strings ST1 to STx in the maintenance mode includes an instruction to individually control the bypass switch units BSU1 to BSUx. An item of the state estimation instruction in the state estimation mode includes executing charge and discharge at a constant current and recording the voltage between the terminals of the storage batteries B1 to Bx at that time.

The string controllers SC1 to SCx receive the above-described instruction information corresponding to each of the strings ST1 to STx from the string system controller SSC, and determine whether a bypass schedule of each of the strings ST1 to STx needs to be updated by comparing the currently received instruction information with the previously received instruction information. The bypass schedule of each of the strings ST1 to STx is a plan related to bypassing of the storage batteries B1 to Bx by the bypass switch units BSU1 to BSUx, and is determined based on a predetermined reference. The string controllers SC1 to SCx determine whether switching of charge to discharge or discharge to charge is executed in each of the strings ST1 to STx, and determine that the bypass schedule needs to be updated in a case where the switching is executed. In a case where the bypass schedule needs to be updated, the string controllers SC1 to SCx determine the bypass schedule of the storage batteries B1 to Bx based on the storage battery state information received from the module controllers MC1 to MCx and an estimation result of the states of the storage batteries B1 to Bx.

On the other hand, the string controllers SC1 to SCx determine whether string input and output power needs to be controlled by comparing the current and previous storage battery state information received from the module controllers MC1 to MCx and the current and previous estimation results of the states of the storage batteries B1 to Bx. The string controllers SC1 to SCx control the power converters PC1 to PCx in a case where the control of the string input and output power is required.

The string controllers SC1 to SCx control the power converters PC1 to PCx according to the charge and discharge power instruction value received from the string system controller SSC.

In a case where the maintenance and stop instruction is received from the string system controller SSC, the string controllers SC1 to SCx analyze the received maintenance and stop instruction and determine a type of maintenance to be executed. The type of the maintenance includes individual control, self-diagnosis, replacement of the storage batteries B1 to Bx (hereinafter, referred to as storage battery replacement), and the like.

The individual control includes a control of individually turning on and off the string interruption switch 11, the cooling devices in the strings ST1 to STx, and the like. The self-diagnosis includes executing abnormality determination for determining an abnormality that determination is difficult to be executed during operation in the state estimation mode or the charge and discharge mode. The abnormality determination includes executing a specific control on the string auxiliary device 5 such as the power converters PC1 to PCx and the bypass switch units BSU1 to BSUx, and acquiring responses thereof by various sensors to determine whether there is an abnormality. The storage battery replacement includes guiding a replacement of deteriorated storage batteries B1 to Bx of failed storage batteries B1 to Bx. When the storage battery replacement is to be executed, a work guide is displayed on the display input device 8 of the electricity storage system controller PSC, and a necessary control such as stopping the strings ST1 to STx subjected to the storage battery replacement is executed in the electricity storage system 1. The strings ST1 to STx not subjected to the storage battery replacement may be caused to operate in the charge and discharge mode. After the storage battery replacement is completed, the strings ST1 to STx in which the storage battery replacement is executed are operated in the state estimation mode, and the storage battery state information is transmitted from the module controllers MC1 to MCx to the string controllers SC1 to SCx. The strings ST1 to STx not subjected to the storage battery replacement may be caused to operate in the charge and discharge mode.

In a case where the state estimation instruction is received from the string system controller SSC, the string controllers SC1 to SCx compare the currently received string input and output power instruction value with the previously received string input and output power instruction value, and determine whether there is a change. In a case where there is a change in the string input and output power instruction value between the previous time and the current time, the string controllers SC1 to SCx control the string auxiliary device 5 and the bypass switch units BSU1 to BSUx by a predetermined method such that the state estimation of the strings ST1 to STx can be executed. The method of controlling the string auxiliary device 5 at the time of executing the state estimation mode includes a method of executing a constant current control on the power converters PC1 to PCx by turning on the string interruption switch 11. In addition, the method of controlling the bypass switch units BSU1 to BSUx at the time of executing the state estimation mode includes a method of sequentially bypassing the storage batteries B1 to Bx which are fully discharged at the time of discharge.

The string controllers SC1 to SCx record the storage battery state information received from the module controllers MC1 to MCx. In addition, the string controllers SC1 to SCx update parameters used when the state estimation is executed as necessary based on the storage battery state information received from the module controllers MC1 to MCx. The parameters include the SOH of the storage batteries B1 to Bx, a map of input and output limit values of the storage batteries B1 to Bx, and SOC-OCV characteristics.

### <Charge and Discharge Mode>

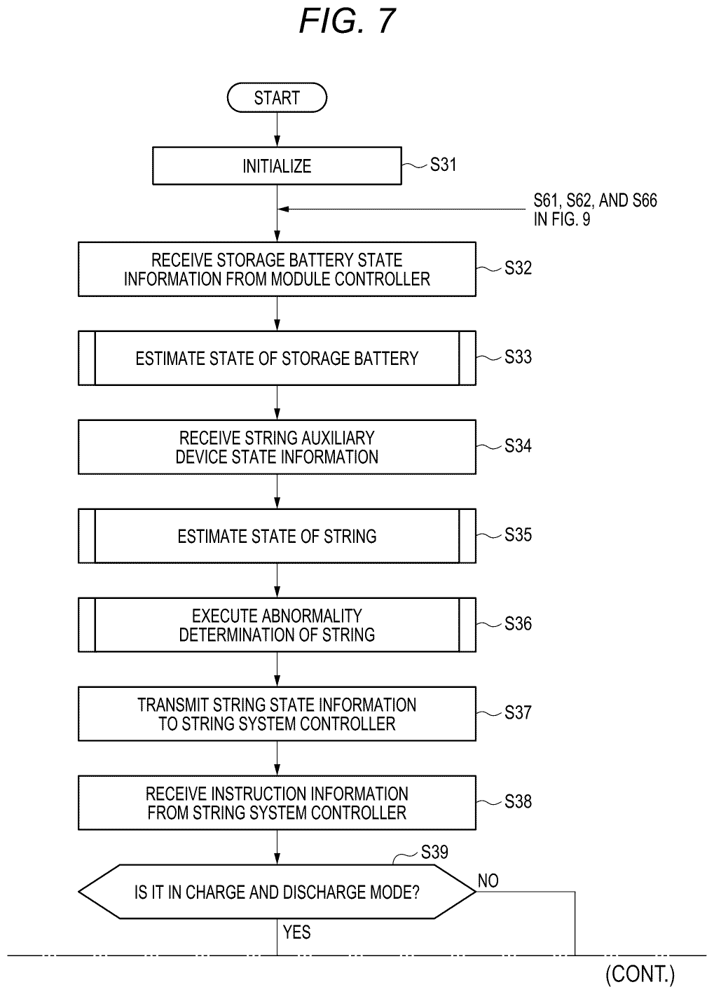

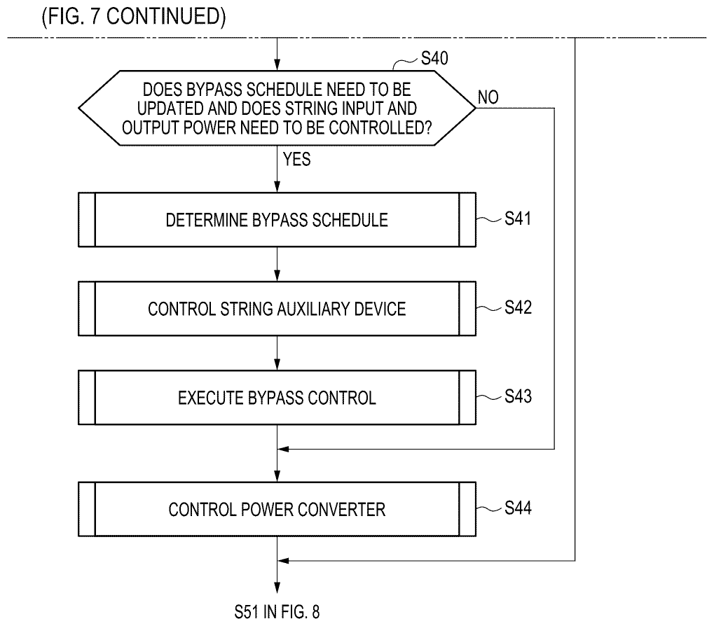

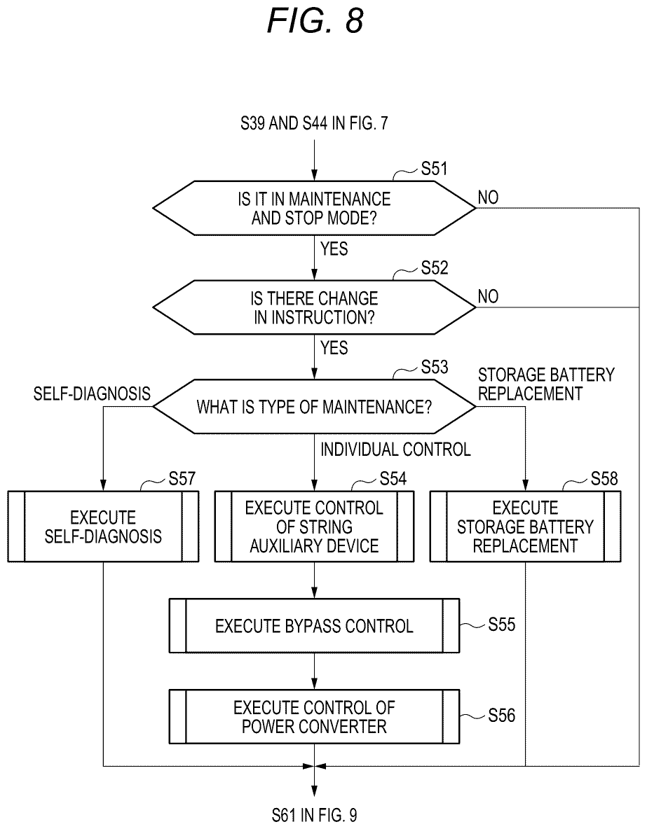

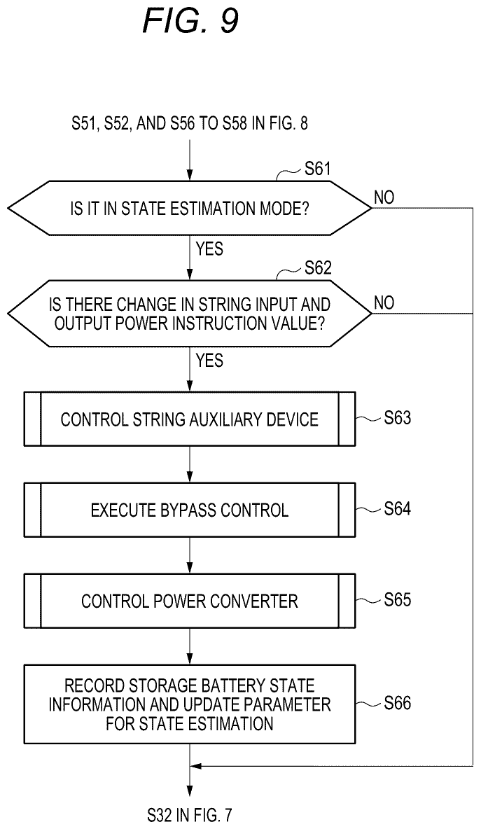

FIGS. 7 to 9 are flowcharts for illustrating processes of the string controllers SC1 to SCx. The process illustrated in the flowchart is started and proceeds to step S31 when the electricity storage system 1 is operated, and steps S32 to S66 are repeated while the electricity storage system 1 is operated.

In step S31, the string controllers SC1 to SCx initialize various parameters. Next, in step S32, the string controllers SC1 to SCx receive the storage battery state information from each of the module controllers MC1 to MCx. Next, in step S33, the string controllers SC1 to SCx estimate the states (SOC, SOH, input and output power limit value, and the like) of the storage batteries B1 to Bx based on the storage battery state information received in step S32.

Next, in step S34, the string controllers SC1 to SCx receive the string auxiliary device state information from the string auxiliary device 5. The state of the string auxiliary device 5 includes the string total voltage, the string current, a state of the string interruption switch 11, and states of the power converters PC1 to PCx.

Next, in step S35, the string controllers SC1 to SCx estimate the states of the strings ST1 to STx based on the information received in steps S32 to S34. The estimation of the states of the strings ST1 to STx may be executed by the string system controller SSC. In this case, the string system controller SSC may transmit an estimation result thereof to the string controllers SC1 to SCx and the electricity storage system controller PSC.

Next, in step S36, the string controllers SC1 to SCx analyze the information received in steps S32 to S34 and the estimation result in step S35, and determine whether there is an abnormality in the strings ST1 to STx. The string controllers SC1 to SCx determine whether there is an abnormality in the strings ST1 to STx by, for example, comparing various detected values and estimated values obtained in steps S32 to S35 with a threshold value.

Next, in step S37, the string controllers SC1 to SCx transmit, to the string system controller SSC, information required for a controller of an upper hierarchy and the process of the host server 7 among the information obtained in steps S32 to S36. Next, in step S38, the string controllers SC1 to SCx receive instruction information transmitted from the string system controller SSC. Here, the string system controller SSC determines an instruction corresponding to the strings ST1 to STx (string input and output power instruction value or bypass permission and non-permission in charge and discharge mode or state estimation mode, individual control instruction in maintenance mode, and the like) based on the information received from the string controllers SC1 to SCx in step S37, and transmits instruction information to the string controllers SC1 to SCx in step S38.

Next, in step S39, the string controllers SC1 to SCx determine whether a charge and discharge instruction is included in the instruction information received from the string system controller SSC in step S38. In a case where the determination in step S39 is YES, the process proceeds to step S40, and in a case where the determination in step S39 is NO, the process proceeds to step S51 in FIG. 8. In step S39, the string controllers SC1 to SCx may determine whether the instruction is an instruction related to any of the charge and discharge mode, the maintenance and stop mode, and the state estimation mode. In this case, when the instruction is the instruction related to the charge and discharge mode, the process may proceed to step S40, when the instruction is the instruction related to the maintenance and stop mode, the process may proceed to step S51 in FIG. 8, and when the instruction is the instruction related to the state estimation mode, the process may proceed to step S61 in FIG. 9.

In step S40 in FIG. 7, the string controllers SC1 to SCx compare the charge and discharge instruction received in step S38 with the previously received charge and discharge instruction, and determine whether the bypass schedule needs to be updated and whether the string input and output power needs to be controlled. For example, the string controllers SC1 to SCx determine whether switching of charge to discharge or discharge to charge is executed in each of the strings ST1 to STx, and determine that the bypass schedule needs to be updated in a case where the switching is executed. On the other hand, the string controllers SC1 to SCx determine whether the control of the string input and output power is required by comparing the current and previous information received from the module controllers MC1 to MCx or estimated by the string controllers SC1 to SCx. In step S40, in a case where the determination is YES for at least one of whether the bypass schedule needs to be updated and whether the string input and output power needs to be controlled as described above, the process proceeds to step S41. On the other hand, in S40, in a case where the determination is NO for both whether the bypass schedule needs to be updated and whether the string input and output power needs to be controlled as described above, the process proceeds to step S44.

In step S41, the string controllers SC1 to SCx determine the bypass schedule of the storage batteries B1 to Bx based on the storage battery state information received from the module controllers MC1 to MCx and the estimation result of the states of the storage batteries B1 to Bx. Next, in step S42, the string controllers SC1 to SCx control the string auxiliary device 5 based on the information obtained in steps S32 to S38. The string controllers SC1 to SCx execute, for example, operations of the cooling devices (not shown) in the strings ST1 to STx, a control of the string interruption switch 11, and the like.

Next, in step S43, the string controllers SC1 to SCx execute the bypass control after a condition for executing the bypass control is satisfied. The string controllers SC1 to SCx compare the storage battery state information (SOH and the like of storage batteries B1 to Bx) received in step S32 and the bypass permission and non-permission received in step S38 with the bypass schedule determined in step S41, and determine whether the above condition is satisfied or not.

Next, in step S44, the string controllers SC1 to SCx control the power converters PC1 to PCx according to the string input and output power instruction value received from the string system controller SSC in step S38. The process proceeds from step S44 to step S51 in FIG. 8.

### <Maintenance and Stop Mode>

In step S51 in FIG. 8, the string controllers SC1 to SCx determine whether the maintenance and stop instruction is included in the instruction information received from the string system controller SSC in step S38 in FIG. 7. In a case where the determination in step S51 is YES, the process proceeds to step S52, and in a case where the determination in step S51 is NO, the process proceeds to step S61 in FIG. 9.

In step S52 in FIG. 8, the string controllers SC1 to SCx compare the maintenance and stop instruction received in step S38 with the previously received maintenance and stop instruction, and determine whether there is a change in the maintenance and stop instruction. In a case where the determination in step S52 is YES, the process proceeds to step S53, and in a case where the determination in step S52 is NO, the process proceeds to step S61 in FIG. 9.

In step S53 in FIG. 8, the string controllers SC1 to SCx analyze the maintenance and stop instruction received from the string system controller SSC in step S38 and determine a type of maintenance to be executed. In a case where the type of maintenance to be executed is the individual control, the process proceeds to step S54, in a case where the type of maintenance to be executed is the self-diagnosis, the process proceeds to step S57, and in a case where the type of maintenance to be executed is the storage battery replacement, the process proceeds to step S58.

In step S54, the string controllers SC1 to SCx determine whether the operation confirmation of the string auxiliary device 5 is included in the individual control instruction input through the display input device 8, and execute the control of the string auxiliary device 5 in a case where the operation confirmation is included. The control of the string auxiliary device 5 includes a control of individually causing the string interruption switch 11 or the cooling devices in the strings ST1 to STx to operate.

Next, in step S55, the string controllers SC1 to SCx determine whether operation confirmation of the bypass switch units BSU1 to BSUx is included in the individual control instruction input through the display input device 8, and execute a control of the bypass switch units BSU1 to BSUx in a case where the operation confirmation is included. Next, in step S56, the string controllers SC1 to SCx determine whether operation confirmation of the power converters PC1 to PCx is included in the individual control instruction input through the display input device 8, and execute a control of the power converters PC1 to PCx in a case where the operation confirmation is included. The process proceeds from step S56 to step S61 in FIG. 9.

On the other hand, in step S57, the string controllers SC1 to SCx execute a specific control for the string auxiliary device 5, the bypass switch units BSU1 to BSUx, or the like for executing self-diagnosis. In this case, the string controllers SC1 to SCx determine whether there is an abnormality in the strings ST1 to STx based on detection information detected by various sensors. The process proceeds from step S57 to step S61 in FIG. 9.

In step S58, the string controllers SC1 to SCx execute a necessary control for the string auxiliary device 5 for executing the storage battery replacement according to an instruction input to the display input device 8 by the operator. The process proceeds from step S58 to step S61 in FIG. 9.

### <State Estimation Mode>

In step S61 in FIG. 9, the string controllers SC1 to SCx determine whether the state estimation instruction is included in the instruction information received from the string system controller SSC in step S38 in FIG. 7. In a case where the determination in step S61 is YES, the process proceeds to step S62, and in a case where the determination in step S61 is NO, the process proceeds to step S32 in FIG. 7.

In step S62 in FIG. 9, the string controllers SC1 to SCx compare the string input and output power instruction value received in step S38 with the previously received string input and output power instruction value, and determine whether there is a change in the string input and output power instruction value. In a case where the determination in step S62 is YES, the process proceeds to step S63, and in a case where the determination in step S62 is NO, the process proceeds to step S32 in FIG. 7.

In step S63 in FIG. 9, the string controllers SC1 to SCx control the string auxiliary device 5 by a predetermined method such that the state estimation of the strings ST1 to STx can be executed. Next, in step S64, the string controllers SC1 to SCx control the bypass switch units BSU1 to BSUx by a predetermined method for executing the state estimation of the strings ST1 to STx.

Next, in step S65, the string controllers SC1 to SCx control the power converters PC1 to PCx according to the string input and output power instruction value received in step S38 in FIG. 7. Next, in step S66, the string controllers SC1 to SCx record the storage battery state information received from the module controllers MC1 to MCx. In addition, the string controllers SC1 to SCx update parameters used when the state estimation is executed as necessary based on the storage battery state information received from the module controllers MC1 to MCx. The process proceeds from step S66 to step S32 in FIG. 7, and steps S32 to S66 are repeated during the operation of the electricity storage system 1.

### <Module Controllers MC1 to MCx>

The module controllers MC1 to MCx shown in FIG. 4 communicate with the string controllers SC1 to SCx, and control and manage a module auxiliary device (not shown). The module auxiliary device includes the bypass switch units BSU1 to BSUx and various sensors. The various sensors include a voltage sensor that detects a voltage of the storage batteries B1 to Bx, a current sensor that detects a current of the storage batteries B1 to Bx, a temperature sensor that detects a temperature of the storage batteries B1 to Bx, and a cell voltage sensor that detects a cell voltage.

The module controllers MC1 to MCx receive the storage battery state information from a cell monitoring unit (not shown) or the like. The states of the storage batteries B1 to Bx include the total voltage of the storage batteries B1 to Bx, the temperature of the storage batteries B1 to Bx, and the cell voltage. The cell monitoring unit receives detection signals from various sensors such as a module voltage sensor for detecting a module voltage, a cell voltage sensor for detecting a cell voltage, and a module temperature sensor for detecting a module temperature. The cell monitoring unit may be implemented as a single unit, or may be implemented using battery cell monitoring ICs in the module controllers MC1 to MCx.

The module controllers MC1 to MCx receive the storage battery state information from the above-described cell monitoring unit or various sensors of the storage batteries B1 to Bx, and estimate the states of the storage batteries B1 to Bx based on the received information. The states of the storage batteries B1 to Bx to be estimated include the SOC, the SOH, the input and output power limit value, and the like of the storage batteries B1 to Bx. The states of the storage batteries B1 to Bx may be estimated by the string controllers SC1 to SCx.

For example, in a case where detected values of the voltage sensor, the cell voltage sensor, and the module temperature sensor or estimated values of the states of the storage batteries B1 to Bx are out of a range of a threshold value, the module controllers MC1 to MCx determine whether there is an abnormality in the storage batteries B1 to Bx. The module controllers MC1 to MCx interrupt the storage batteries B1 to Bx for which the abnormality determination is executed by the bypass switch units BSU1 to BSUx or transmit an abnormality notification to the string controllers SC1 to SCx.

The module controllers MC1 to MCx transmit, to the string controllers SC1 to SCx, information required for a process of a host controller such as the string controllers SC1 to SCx among information received from the cell monitoring unit or the various sensors and information estimated by the module controllers MC1 to MCx. The information required for the process of the string controllers SC1 to SCx includes the temperature, the current, the voltage, the SOC, the SOH, the input and output power limit value, and the cell voltage of the storage batteries B1 to Bx, and the states of the bypass switch units BSU1 to BSUx.

Here, the string controllers SC1 to SCx determine an instruction corresponding to each of the storage batteries B1 to Bx based on the “information required for the process of the string controllers SC1 to SCx” received from the module controllers MC1 to MCx, and transmit instruction information to the module controllers MC1 to MCx. The instruction includes a bypass control of the storage batteries B1 to Bx by the bypass switch units BSU1 to BSUx, and an interruption control of the storage batteries B1 to Bx by the bypass switch units BSU1 to BSUx.

In a case where there is a change in the current and previous instruction information received from the string controllers SC1 to SCx, the module controllers MC1 to MCx control the bypass switch units BSU1 to BSUx and execute the above-described bypass control or interruption control. In addition, in a case where there is a change in the information received from the cell monitoring unit or the various sensors and the information estimated by the module controllers MC1 to MCx, the module controllers MC1 to MCx execute an exception control which does not depend on the instruction from the host controller as necessary.

The module controllers MC1 to MCx transmit an instruction to execute cell balancing on the storage batteries B1 to Bx to the cell monitoring unit.

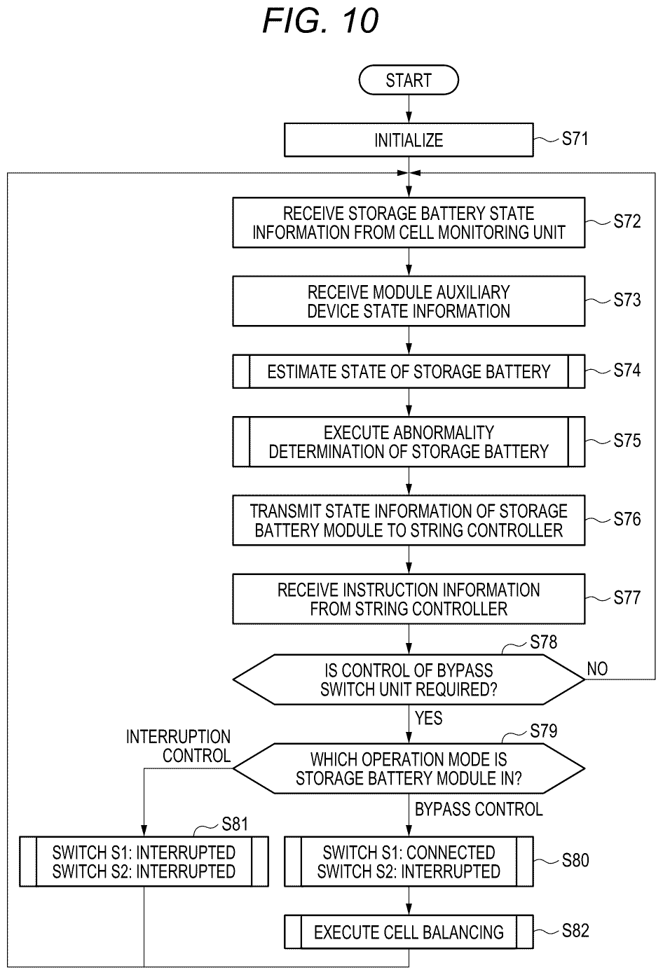

FIG. 10 is a flowchart for illustrating a process of the module controllers MC1 to MCx. The process illustrated in the flowchart is started and proceeds to step S71 when the electricity storage system 1 is operated, and steps S72 to S82 are repeated while the electricity storage system 1 is operated.

In step S71, the module controllers MC1 to MCx initialize various parameters. Next, in step S72, the module controllers MC1 to MCx receive the storage battery state information from the cell monitoring unit or various sensors. Next, in step S73, the module controllers MC1 to MCx acquire information on a state of the module auxiliary device (hereinafter, referred to as module auxiliary device state information). The state of the module auxiliary device includes an atmospheric temperature, the current, and the voltage of the storage batteries B1 to Bx, the states of the bypass switch units BSU1 to BSUx, and the like.

Next, in step S74, the module controllers MC1 to MCx estimate the states (SOH and the like) of the storage batteries B1 to Bx based on the information received in steps S72 and S73. Next, in step S75, the module controllers MC1 to MCx determine whether there is an abnormality in the storage batteries B1 to Bx based on the information obtained in steps S72 to S74. The module controllers MC1 to MCx determine whether there is an abnormality in the storage batteries B1 to Bx by, for example, comparing various detected values or estimated values acquired in steps S72 to S75 with a threshold value.

Next, in step S76, the module controllers MC1 to MCx transmit, to the string controllers SC1 to SCx, information required for the process of the host controller such as the string controllers SC1 to SCx among the information obtained in steps S72 to S75. Next, in step S77, the module controllers MC1 to MCx receive instruction information transmitted from the string controllers SC1 to SCx. Here, the string controllers SC1 to SCx determine an instruction (bypass control instruction, interruption control instruction, and the like) corresponding to the storage batteries B1 to Bx based on the information received from the module controllers MC1 to MCx in step S76, and transmit instruction information to the module controllers MC1 to MCx in step S77.

Next, in step S78, the module controllers MC1 to MCx compare the instruction information received in step S77 with the previously received instruction information, and determine whether the control of the bypass switch units BSU1 to BSUx is required. In addition, in step S78, the module controllers MC1 to MCx determine whether there is a change in the information acquired in steps S72 to S75 and the exception control (control not depend on instruction from host controller) is required. In a case where any of the determinations in step S78 is YES, the process proceeds to step S79, and in a case where both the determinations in step S78 are NO, the process proceeds to step S72.

In step S79, the module controllers MC1 to MCx determine whether the bypass control instruction or the interruption control instruction is included in the instruction information received from the string controllers SC1 to SCx in step S77. In a case where the bypass control instruction is included, the process proceeds to step S80, and in a case where the interruption control instruction is included, the process proceeds to step S81.

In step S80, the module controllers MC1 to MCx control the bypass switch units BSU1 to BSUx by a predetermined control method to bypass target storage batteries B1 to Bx (switch S1: connected, switch S2: interrupted). On the other hand, in step S81, the module controllers MC1 to MCx set the switches S1 and S2 of target bypass switch units BSU1 to BSUx to an interrupted state.

The process proceeds from step S80 to step S82, and in step S82, the module controllers MC1 to MCx execute the cell balancing of the storage batteries B1 to Bx to equalize the cell voltages of the storage batteries B1 to Bx. The process proceeds from steps S81 and S82 to step S72, and steps S72 to S82 are repeated during the operation of the electricity storage system 1.

As described above, the storage battery control device 2 of the present embodiment includes the plurality of first control devices 21 provided respectively for the strings ST1 to STx, and the second control device 22 that communicates with the plurality of first control devices 21 and the host server 7 outside the electricity storage system 1 (see FIG. 4). The first control device 21 acquires the string state information from the various sensors and the like and transmits the string state information to the second control device 22. The second control device 22 calculates the charge and discharge power instruction value assigned to each of the plurality of strings ST1 to STx based on the charge and discharge power (or current, the same shall apply hereinafter) instruction value of the electricity storage system 1 received from the host server 7 and the plurality of pieces of string state information received from the plurality of first control devices 21, and transmits the charge and discharge power instruction value to the first control device 21. The first control device 21 controls the auxiliary devices (string auxiliary device 5 and module auxiliary device) of the strings ST1 to STx such as the bypass switch units BSU1 to BSUx according to the charge and discharge power instruction value of the strings ST1 to STx received from the second control device 22.

Accordingly, in a large-scale electricity storage system 1 including a large number of strings ST1 to STx and further including a large number of storage batteries B1 to Bx and a large number of auxiliary devices such as a large number of bypass switch units BSU1 to BSUx, an amount of stored power of the large number of strings ST1 to STx and an amount of stored power of the large number of storage batteries B1 to Bx can be managed. Accordingly, it is possible to execute a charge and discharge control of the large-scale electricity storage system 1 in response to a request of the DR. On the other hand, since the storage battery control device 2 is implemented by the second control device 22 of an upper hierarchy that processes the instruction from the host server 7 or the display input device 8 outside the electricity storage system 1 and the first control device 21 of a lower hierarchy that executes state detection of each of the strings ST1 to STx and a control of the auxiliary devices, it is possible to avoid complexity of the control in the electricity storage system 1 and appropriately prevent a processing load of the storage battery control device 2.

In the storage battery control device 2 of the present embodiment, the second control device 22 transmits the instruction information input from the display input device 8 included in the electricity storage system 1 to the first control device 21, and the first control device 21 controls the auxiliary devices of the strings ST1 to STx according to the instruction information received from the second control device 22. That is, the second control device 22 of the upper hierarchy executes a reception process of the instruction information input by the operator or the like through the display input device 8, and the first control device 21 of the lower hierarchy executes a control of the auxiliary devices of the strings ST1 to STx corresponding to the instruction information. Accordingly, it is possible to smoothly execute various operation modes according to instructions of the operator or the like such as the maintenance and stop mode, the state estimation mode, and the charge and discharge mode while appropriately preventing the processing load of the storage battery control device 2.

In the storage battery control device 2 of the present embodiment, the second control device 22 generates the state estimation instruction for the strings ST1 to STx according to the information on the states of the strings ST1 to STx received from the first control device 21, and transmits the state estimation instruction to the first control device 21. The first control device 21 controls the auxiliary devices of the strings ST1 to STx according to the state estimation instruction information received from the second control device 22. Accordingly, it is possible to execute the state estimation mode at an appropriate timing while appropriately preventing the processing load of the storage battery control device 2.

In the storage battery control device 2 of the present embodiment, any of the first control device 21 and the second control device 22 estimates the states of the strings ST1 to STx. The second control device 22 calculates the charge and discharge power instruction value of the strings ST1 to STx based on the detection information on the states of the strings ST1 to STx detected by the various sensors of the strings ST1 to STx and the estimation information on the states of the strings ST1 to STx estimated by the first control device 21 or the second control device 22. Accordingly, it is possible to execute a charge and discharge control of each of the strings ST1 to STx while appropriately preventing the processing load of the storage battery control device 2.

In the storage battery control device 2 of the present embodiment, any of the first control device 21 and the second control device 22 determines whether there is an abnormality in the strings ST1 to STx based on the above-described detection information and estimation information and the string auxiliary device state information. Here, since the string auxiliary device state information is acquired by the first control device 21 of the lower hierarchy, it is possible to execute the abnormality determination of the strings ST1 to STx while preventing the processing load of the second control device 22.

In the storage battery control device 2 of the present embodiment, the first control device 21 includes the plurality of module controllers MC1 to MCx provided respectively for the modules M1 to Mx and the string controllers SC1 to SCx provided respectively for the strings ST1 to STx. The module controllers MC1 to MCx acquire the storage battery state information from the various sensors and the like, and transmit the storage battery state information to the string controllers SC1 to SCx. The string controllers SC1 to SCx generate the bypass control instruction information according to the storage battery state information received from the module controllers MC1 to MCx and the charge and discharge power instruction value of the strings ST1 to STx received from the second control device 22, and transmit the bypass control instruction information to the module controllers MC1 to MCx. That is, the module controllers MC1 to MCx of a lower hierarchy execute the acquisition of the storage battery state information and the control of the auxiliary devices of the modules M1 to Mx such as the bypass switch units BSU1 to BSUx. On the other hand, the string controllers SC1 to SCx of an upper hierarchy execute the generation of the bypass control instruction information such as the above-described bypass control instruction and interruption control instruction. Accordingly, it is possible to execute the charge and discharge control of the strings ST1 to STx while appropriately preventing the processing load of the first control device 21.

In the storage battery control device 2 of the present embodiment, the second control device 22 includes the string system controller SSC provided for each string system 10 and the electricity storage system controller PSC provided corresponding to the hierarchy of the electricity storage system 1. The string system controller SSC communicates with the first control device 21 and the electricity storage system controller PSC, and controls the string system auxiliary device 4. On the other hand, the electricity storage system controller PSC communicates with the string system controller SSC and the host server 7, and transmits the instruction information input from the display input device 8 to the string system controller SSC. In addition, the electricity storage system controller PSC controls the electricity storage system auxiliary device 3 provided in the hierarchy of the electricity storage system 1. The string system controller SSC transmits the instruction information received from the electricity storage system controller PSC to the first control device 21. That is, the electricity storage system controller PSC of an upper hierarchy executes the processes of the control of the auxiliary devices in the hierarchy of the electricity storage system 1 and the reception of the instruction information. On the other hand, the string system controller SSC of a lower hierarchy executes the processes of the control of the auxiliary devices in the hierarchy of the string system 10 and the transmission of the instruction information. Accordingly, it is possible to execute the control corresponding to the instruction information of the strings ST1 to STx while appropriately preventing the processing load of the second control device 22.

Although the present invention has been described above based on the above embodiment, the present invention is not limited to the above embodiment, and modifications may be made without departing from the gist of the present invention, or publicly known or well-known techniques may be appropriately combined.

For example, in the embodiment described above, the first control device 21 is implemented by the string controller SC1 and the module controllers MC1 to MCx, but the first control device 21 may be implemented by a single controller. In the embodiment described above, the second control device 22 is implemented by the electricity storage system controller PSC and the string system controller SSC, but the second control device 22 may be implemented by a single controller.

Here, features of embodiments of the storage battery control device and the electricity storage system according to the present invention described above will be briefly summarized and listed in the following [1] to [11].

[1] A storage battery control device (2) for controlling an electricity storage system including a plurality of storage battery strings (ST1 to STx) connected in parallel, the storage battery string including a plurality of storage batteries (B1 to Bx) connected in series, a plurality of bypass circuits (BSU1 to BSUx) that are provided respectively for the storage batteries and configured to switch the storage batteries between a bypass state and a connected state, and a power converter (PC1 to PCx) configured to convert input and output power of the storage battery string, the storage battery control device including:
a plurality of first control units (21) that are provided respectively for the storage battery strings and configured to control auxiliary devices (5) of the storage battery strings including the power converter (PC1 to PCx) and the bypass circuits; and
a second control unit (22) configured to communicate with the plurality of first control units and a system outside the electricity storage system, in which
the first control unit is configured to acquire information on states of the storage battery strings and transmit the information to the second control unit,
the second control unit is configured to calculate an instruction value of charge and discharge power or a charge and discharge current assigned to each of the plurality of storage battery strings based on an instruction value of charge and discharge power or a charge and discharge current of the electricity storage system received from the system outside the electricity storage system and the information on the states of the plurality of storage battery strings received from the plurality of first control units, and transmit the instruction value to the first control unit, and
the first control unit is configured to control the auxiliary devices of the storage battery strings according to the instruction value of the charge and discharge power or the charge and discharge current of the storage battery string received from the second control unit.

[2] The storage battery control device according to [1], in which
the second control unit is configured to transmit instruction information input from an instruction input unit (8) included in the electricity storage system to the first control unit, and
the first control unit is configured to control the auxiliary devices of the storage battery strings according to the instruction information received from the second control unit.

[3] The storage battery control device according to [2], in which
the instruction information is maintenance instruction information for instructing maintenance of the storage battery string, and
the first control unit is configured to control the auxiliary devices of the storage battery strings according to the maintenance instruction information received from the second control unit.

[4] The storage battery control device according to [1] or [2], in which
the second control unit is configured to generate state estimation instruction information for instructing state estimation of the storage battery string according to the information on the states of the storage battery strings received from the first control unit and transmits the state estimation instruction information to the first control unit, and
the first control unit is configured to control the auxiliary devices of the storage battery strings according to the state estimation instruction information received from the second control unit.

[5] The storage battery control device according to [2], in which
the instruction information is state estimation instruction information for instructing state estimation of the storage battery string, and
the first control unit is configured to control the auxiliary devices of the storage battery strings according to the state estimation instruction information received from the second control unit.

[6] The storage battery control device according to [2], in which
the instruction information is charge and discharge instruction information for instructing charge and discharge of the storage battery string, and
the first control unit is configured to control the auxiliary devices of the storage battery strings according to the charge and discharge instruction information received from the second control unit.

[7] The storage battery control device according to [1] or [2], in which
the information on the states of the storage battery strings includes detection information detected by a state detection unit (12 to 14) included in the storage battery string and estimation information estimated by the first control unit or the second control unit based on the detection information.

[8] The storage battery control device according to [6], in which
the information on the states of the storage battery strings includes information on states of the auxiliary devices of the storage battery strings acquired by the first control unit, and
the first control unit or the second control unit is configured to determine whether there is an abnormality in the storage battery strings based on the information on the states of the storage battery strings.

[9] The storage battery control device according to [1] or [2], in which
the storage battery string includes
a plurality of modules (M1 to Mx) including the storage battery and the bypass circuit, and
string auxiliary devices (5) including the power converter,
the first control unit includes
a plurality of module control units (MC1 to MCx) that are provided respectively for the modules and configured to control the bypass circuit, and
a string control unit (SC1 to SCx) that is provided for each of the storage battery strings, and configured to communicate with the module control unit and the second control unit and control the string auxiliary devices,
the module control unit is configured to acquire information on a state of the storage battery and transmit the information to the string control unit,
the string control unit is configured to generate bypass control instruction information for controlling the bypass circuit according to the information on the state of the storage battery received from the module control unit and the instruction value of the charge and discharge power or the charge and discharge current of the storage battery string received from the second control unit, transmit the bypass control instruction information to the module control unit, and control the power converter, and
the module control unit is configured to control the bypass circuit according to the bypass control instruction information received from the string control unit.

[10] The storage battery control device according to [2], in which
the electricity storage system includes
a single or a plurality of string systems (10) each including a plurality of the storage battery strings,
the second control unit includes
a string system control unit (SSC) that is provided for each of the string systems, and configured to communicate with the first control unit and control auxiliary devices included in the string system, and
an electricity storage system control unit (PSC) configured to communicate with the string system control unit and the system outside the electricity storage system, transmit the instruction information input from the instruction input unit to the string system control unit, and control auxiliary devices (3) different from the auxiliary devices (4 and 5) included in the storage battery strings and the string system, and
the string system control unit is configured to transmit the instruction information received from the electricity storage system control unit to the first control unit.

[11] An electricity storage system including:
a plurality of storage battery strings connected in parallel; and
a storage battery control device,
the storage battery string including
a plurality of storage batteries connected in series,
a plurality of bypass circuits that are provided respectively for the storage batteries and configured to switch the storage batteries between a bypass state and a connected state, and
a power converter configured to convert input and output power of the storage battery string, in which
the storage battery control device includes
a plurality of first control units that are provided respectively for the storage battery strings and configured to control auxiliary devices of the storage battery strings including the power converter and the bypass circuits, and
a second control unit configured to communicate with the plurality of first control units and a system outside the electricity storage system,
the first control unit is configured to acquire information on states of the storage battery strings and transmit the information to the second control unit,
the second control unit is configured to calculate an instruction value of charge and discharge power or a charge and discharge current assigned to each of the plurality of storage battery strings based on an instruction value of charge and discharge power or a charge and discharge current of the electricity storage system received from the system outside the electricity storage system and the information on the states of the plurality of storage battery strings received from the plurality of first control units, and transmit the instruction value to the first control unit, and
the first control unit is configured to control the auxiliary devices of the storage battery strings according to the instruction value of the charge and discharge power or the charge and discharge current of the storage battery string received from the second control unit.

The present application is based on a Japanese patent application (Japanese Patent Application No. 2022-189832) filed on Nov. 29, 2022, and the contents thereof are incorporated herein by reference.

### INDUSTRIAL APPLICABILITY

According to the present invention, it is possible to provide a storage battery control device and an electricity storage system capable of managing an amount of stored power in a unit of a storage battery string and a unit of a storage battery and appropriately preventing a processing load of a control device even in a large-scale electricity storage system. The present invention having this effect is useful for the storage battery control device and the electricity storage system.

### REFERENCE SIGNS LIST

1: electricity storage system
2: storage battery control device
3: electricity storage system auxiliary device (auxiliary devices)
4: string system auxiliary device (auxiliary devices)
5: string auxiliary device (storage battery string auxiliary devices and string auxiliary devices)
7: host server (system outside of electricity storage system)
8: display input device (instruction input unit)
10: string system
11: string interruption switch (storage battery string auxiliary devices and string auxiliary devices)
12: voltage sensor (state detection unit and storage battery string auxiliary devices)
13: current sensor (state detection unit, storage battery string auxiliary devices, and string auxiliary devices)
14: voltage sensor (state detection unit, storage battery string auxiliary devices, and string auxiliary devices)
21: first control device (first control unit)
22: second control device (second control unit)
B1 to Bx: storage battery
BSU1 to BSUx: bypass switch unit (bypass circuit and storage battery string auxiliary devices)
M1 to Mx: module
MC1 to MCx: module controller (module control unit)
PC1 to PCx: power converter (storage battery string auxiliary devices and string auxiliary devices)
PSC: electricity storage system controller (electricity storage system control unit)
ST1 to STx: string (storage battery string)
SC1 to SCx: string controller (string control unit)
SSC: string system controller (string system control unit)

1. A storage battery control device for controlling an electricity storage system including a plurality of storage battery strings connected in parallel, the storage battery string including a plurality of storage batteries connected in series, a plurality of bypass circuits that are provided respectively for the storage batteries and configured to switch the storage batteries between a bypass state and a connected state, and a power converter configured to convert input and output power of the storage battery string, the storage battery control device comprising:
a plurality of first control units that are provided respectively for the storage battery strings and configured to control auxiliary devices of the storage battery strings including the power converter and the bypass circuits; and
a second control unit configured to communicate with the plurality of first control units and a system outside the electricity storage system, wherein:
the first control unit is configured to acquire information on states of the storage battery strings and transmit the information to the second control unit;
the second control unit is configured to calculate an instruction value of charge and discharge power or a charge and discharge current assigned to each of the plurality of storage battery strings based on an instruction value of charge and discharge power or a charge and discharge current of the electricity storage system received from the system outside the electricity storage system and the information on the states of the plurality of storage battery strings received from the plurality of first control units, and transmit the instruction value to the first control unit; and
the first control unit is configured to control the auxiliary devices of the storage battery strings according to the instruction value of the charge and discharge power or the charge and discharge current of the storage battery string received from the second control unit.

2. The storage battery control device according to claim 1, wherein:
the second control unit is configured to transmit instruction information input from an instruction input unit included in the electricity storage system to the first control unit; and
the first control unit is configured to control the auxiliary devices of the storage battery strings according to the instruction information received from the second control unit.

3. The storage battery control device according to claim 2, wherein:
the instruction information is maintenance instruction information for instructing maintenance of the storage battery string; and
the first control unit is configured to control the auxiliary devices of the storage battery strings according to the maintenance instruction information received from the second control unit.

4. The storage battery control device according to claim 1, wherein:
the second control unit is configured to generate state estimation instruction information for instructing state estimation of the storage battery string according to the information on the states of the storage battery strings received from the first control unit and transmits the state estimation instruction information to the first control unit; and
the first control unit is configured to control the auxiliary devices of the storage battery strings according to the state estimation instruction information received from the second control unit.

5. The storage battery control device according to claim 2, wherein:
the instruction information is state estimation instruction information for instructing state estimation of the storage battery string; and
the first control unit is configured to control the auxiliary devices of the storage battery strings according to the state estimation instruction information received from the second control unit.

6. The storage battery control device according to claim 2, wherein:
the instruction information is charge and discharge instruction information for instructing charge and discharge of the storage battery string; and
the first control unit is configured to control the auxiliary devices of the storage battery strings according to the charge and discharge instruction information received from the second control unit.

7. The storage battery control device according to claim 1, wherein
the information on the states of the storage battery strings includes detection information detected by a state detection unit included in the storage battery string and estimation information estimated by the first control unit or the second control unit based on the detection information.

8. The storage battery control device according to claim 6, wherein:
the information on the states of the storage battery strings includes information on states of the auxiliary devices of the storage battery strings acquired by the first control unit; and
the first control unit or the second control unit is configured to determine whether there is an abnormality in the storage battery strings based on the information on the states of the storage battery strings.

9. The storage battery control device according to claim 1, wherein:
the storage battery string includes:
a plurality of modules including the storage battery and the bypass circuit; and
string auxiliary devices including the power converter;
the first control unit includes:
a plurality of module control units that are provided respectively for the modules and configured to control the bypass circuit; and
a string control unit that is provided for each of the storage battery strings, and configured to communicate with the module control unit and the second control unit and control the string auxiliary devices;
the module control unit is configured to acquire information on a state of the storage battery and transmit the information to the string control unit;
the string control unit is configured to generate bypass control instruction information for controlling the bypass circuit according to the information on the state of the storage battery received from the module control unit and the instruction value of the charge and discharge power or the charge and discharge current of the storage battery string received from the second control unit, transmit the bypass control instruction information to the module control unit, and control the power converter; and
the module control unit is configured to control the bypass circuit according to the bypass control instruction information received from the string control unit.

10. The storage battery control device according to claim 2, wherein:
the electricity storage system includes
a single or a plurality of string systems each including a plurality of the storage battery strings;
the second control unit includes:
a string system control unit that is provided for each of the string systems, and configured to communicate with the first control unit and control auxiliary devices included in the string system; and
an electricity storage system control unit configured to communicate with the string system control unit and the system outside the electricity storage system, transmit the instruction information input from the instruction input unit to the string system control unit, and control auxiliary devices different from the auxiliary devices included in the storage battery strings and the string system; and
the string system control unit is configured to transmit the instruction information received from the electricity storage system control unit to the first control unit.

11. An electricity storage system comprising:
a plurality of storage battery strings connected in parallel; and
a storage battery control device,
the storage battery string including:
a plurality of storage batteries connected in series;
a plurality of bypass circuits that are provided respectively for the storage batteries and configured to switch the storage batteries between a bypass state and a connected state; and
a power converter configured to convert input and output power of the storage battery string, wherein:
the storage battery control device includes:
a plurality of first control units that are provided respectively for the storage battery strings and configured to control auxiliary devices of the storage battery strings including the power converter and the bypass circuits; and
a second control unit configured to communicate with the plurality of first control units and a system outside the electricity storage system;
the first control unit is configured to acquire information on states of the storage battery strings and transmit the information to the second control unit;
the second control unit is configured to calculate an instruction value of charge and discharge power or a charge and discharge current assigned to each of the plurality of storage battery strings based on an instruction value of charge and discharge power or a charge and discharge current of the electricity storage system received from the system outside the electricity storage system and the information on the states of the plurality of storage battery strings received from the plurality of first control units, and transmit the instruction value to the first control unit; and
the first control unit is configured to control the auxiliary devices of the storage battery strings according to the instruction value of the charge and discharge power or the charge and discharge current of the storage battery string received from the second control unit.
